(19) United States
(12) Patent Application Publication
(10) Pub. No.: US 2002/0140711 A1
(43) Pub. Date: Oct. 3, 2002

(54) Image display device for displaying aspect ratios

(75) Inventors: Junichi Saito, Miyagi-ken (JP); Mitsutaka Yoshida, Kanagawa-ken (JP); Takuya Kawame, Saitama-ken (JP)

Correspondence Address: BEYER WEAVER & THOMAS LLP, P.O. BOX 778, BERKELEY, CA, 94704-0778, US

(73) Assignee: ALPS ELECTRIC CO., LTD.

(21) Appl. No.: 10/100,869

(22) Filed: Mar. 18, 2002

(30) Foreign Application Priority Data
Mar. 28, 2001 (JP) 2001-094126
Mar. 28, 2001 (JP) 2001-094127

(51) Int. Cl. G09G 5/00

(52) U.S. Cl. 345/660

(57) ABSTRACT

An image display device has a display screen with a predetermined aspect ratio. The display screen can display a plurality of sections. A scale corresponding to each section is displayed on a border of each section or on an extension of the border. Scale setters each determine a display attribute of each scale, generate a scale signal indicating the determined display attribute, and replace a predetermined portion of an image signal for displaying an image on the display screen with the scale signal.

### BACKGROUND OF THE INVENTION

1. Field of the Invention

The present invention relates to image display devices, and more particularly to an image display device for displaying display region markers.

2. Description of the Related Art

There are image display devices capable of displaying various markers on the image display screen, and the markers are superimposed on the images. Examples of markers include a frame marker indicating an effective region of an image, a center marker indicating the center of an image, an aspect ratio marker indicating an aspect ratio of 4:3 or the like, and other safety markers.

Among these markers, the aspect ratio marker indicating an aspect ratio of 4:3 or the like is intended to inform a user of the current aspect ratio displayed on the screen. The aspect-ratio marker is indicated by displaying numerals on the image display screen, the numerals being superimposed on the image. Alternatively, the aspect ratio is displayed on an auxiliary display unit, which is a different screen from that displaying the image. The aspect ratio may also be displayed by a light emitting device provided in the casing of the image display device.

The related art described above has the following problems: Specifically, when the aspect ratio is displayed by displaying numerals on the image display screen, the numerals are superimposed on the image and obstruct the user's view. Thus, the user has difficulty in viewing the image. In particular, when the image display device has a small display screen, the ratio of the numeral size to the screen size becomes relatively large. The numerals obstruct the user's view, and thus the user has great difficulty in viewing the image.

When the aspect ratio is displayed on the auxiliary display unit, which is a different screen from that displaying the image, or when the aspect ratio is displayed by the light emitting device provided in the casing of the image display device, an additional space for arranging these displays becomes necessary. As a result, the size of the image display device is increased.

### SUMMARY OF THE INVENTION

In order to solve the foregoing problems, it is an object of the present invention to provide an image display device for displaying an aspect ratio without causing a user difficulty in viewing an image and without increasing the size of the image display device.

According to the present invention, an image display device is provided including a display screen with a predetermined aspect ratio, the display screen being capable of displaying a plurality of sections. A scale is displayed on a border of each section or on an extension of the border. The image display device further includes a scale setter for determining a display attribute of the scale, for generating a scale signal indicating the determined display attribute, and for replacing a predetermined portion of an image signal for displaying an image on the display screen with the scale signal.

Arranged as described above, the scale corresponding to each section is displayed on the border of each section or on the extension of the border. Thus, the region of each section becomes easily detectable.

The scale setter determines the attribute of the scale, generates the scale signal indicating the determined display attribute, and replaces the predetermined portion of the image signal for displaying the image on the display screen with the scale signal. Accordingly, on the display screen, the scale corresponding to each section is displayed on the border of each section or on the extension of the border. Thus, the region of each section becomes easily detectable.

In particular, in an image display device, namely, a viewfinder, for use in a television camera for shooting a television program, there are cases where it is necessary to confirm that an object of shooting is within regions with a plurality of aspect ratios, such as 4:3, 13:9, and 14:9. In such a case, it is useful to provide scales for distinguishing regions with a plurality of aspect ratios, such as 4:3, 13:9, and 14:9, on the screen of the image display device.

Each scale is provided on the border of each section or on the extension of the border. When a pair of scale marks, that is, two scale marks, are displayed at both ends of the display screen, the region of each section can be easily detected. At the same time, the image displayed on the display screen is not obstructed.

Preferably, the image signal and the scale signal for replacing the predetermined portion of the image signal by the scale setter are digital signals in order to accurately set the position and display attribute of each scale.

According to the image display device of the present invention, one of the plurality of sections may be selected as a selected section. A display attribute of a selected scale corresponding to the selected section may be made different from a display attribute of an unselected scale corresponding to an unselected section other than the selected section.

According to the image display device of the present invention, the scale setter may include an attribute setter for generating a plurality of scale signals indicating different display attributes; and a replacement unit for replacing the predetermined portion of the image signal for displaying the image on the display screen with one of the plurality of scale signals generated by the attribute setter.

Arranged as described above, the selected scale and the unselected scale are displayed on the display screen at the same time. Also, the display attribute of the selected scale corresponding to the selected section is made different from the display attribute of the unselected scale corresponding to the unselected section. Thus, a user can detect the aspect ratio indicated by the selected scale.

Since the attribute setter generates a plurality of scale signals indicating different display attributes, the user can distinguish the aspect ratios indicated by the scales from one another. It becomes unnecessary to display the aspect ratios using numerals on the display screen, the numerals being superimposed on the displayed image. Thus, the user can easily view the displayed image. It also becomes unnecessary to display the aspect ratios on an auxiliary display unit, which is a different screen from that displaying the image, or on a light emitting device provided in a casing of the image display device. Thus, an additional space for arranging these displays becomes unnecessary. As a result, the size of the image display device be reduced.

When it is possible to select one from among the plurality of sections, by making the display attribute of the selected scale corresponding to the selected section different from the display attribute of the unselected scale corresponding to the unselected section other than the selected section, the selected section can be easily distinguished from the unselected section. By making the display attributes of the scales corresponding to the plurality of sections different from one another, the sections become easy to distinguish from one another. By changing the display attributes of the scales in accordance with the quality of the image displayed on the display screen and the background color, the scales can be easily detected.

According to the image display device of the present invention, part of the selected scale may be provided on the border of the selected section corresponding to the selected scale and in the vicinity of a central portion of the display screen. The unselected scale may be provided on the border of the unselected section corresponding to the unselected scale and in the vicinity of a peripheral portion of the display screen.

According to the image display device of the present invention, the scale setter may further include a timing determination unit for determining a time at which the replacement unit replaces the predetermined portion of the image signal with one of the plurality of scale signals in accordance with a sync signal of the image displayed on the display screen.

Arranged as described above, part of the selected scale is displayed on the border of the selected section corresponding to the selected scale and in the vicinity of the central portion of the display screen. The unselected scale is provided on the border of the unselected section corresponding to the unselected scale and in the vicinity of the peripheral portion of the display screen. Accordingly, even when a plurality of scales indicating sections with a plurality of aspect ratios are displayed on the display screen, the image is not obstructed by the scales.

Arranged as described above, the timing determination unit determines the time at which the replacement unit replaces the predetermined portion of the image signal with one of the plurality of scale signals in accordance with the sync signal of the image displayed on the display screen. According to the timing generation unit, a plurality of scales of different length can be displayed at different positions on the display screen. For example, the selected scale can be displayed from the peripheral portion of the display screen to the central portion of the display screen, and the unselected scale can be displayed only in the vicinity of the peripheral portion of the display screen. Accordingly, even when a plurality of scales indicating sections with a plurality of aspect ratios is displayed on the display screen, the image is not obstructed by the scales.

Since portion of the selected scale is displayed on the border of the selected section corresponding to the selected scale and in the vicinity of the central portion of the display screen, the region of the selected section can be easily detected.

By determining the time at which the predetermined portion of the image signal is replaced with the scale signal in accordance with the sync signal of the image, the scale can be accurately and easily provided on the image. By forming the timing determination unit, the attribute setter, and the replacement unit using a combinational logic circuit (circuit combining basic gates) and a sequential logic circuit (flip flop circuit or the like), the circuit design of the timing determination unit, the attribute setter, and the replacement unit is simplified, and the circuit is reduced in size. Such features are preferable with regard to circuit integration.

The image display device of the present invention may further include a selector for selecting a desired section from among the plurality of sections as the selected section. In cooperation with a selection operation performed by the selector, a scale corresponding to the selected section may be selected as the selected scale.

According to the image display device of the present invention, the scale setter may further include a switch; and a switching unit for sequentially switching, among the plurality of scale signals generated by the attribute setter, the scale signal for replacing the predetermined portion of the image signal by the replacement unit every time the switch is turned ON.

Arranged as described above, in cooperation with a selection operation performed by the selector, the desired section is selected from among the plurality of sections, and the scale corresponding to the selected section is selected as the selected scale. Thus, the desired section can be selected from among the plurality of sections as the selected section.

Arranged as described above, every time the switch is turned ON, the switching unit switches the scale signal for replacing the predetermined portion of the image signal. Thus, the position of the selected scale can be changed by the single switch, thus reducing the space required for arranging the switch. As a result, the image display device can be reduced in size.

### BRIEF DESCRIPTION OF THE DRAWINGS

FIG. 1 is a block diagram showing the fundamental configuration of an image display device according to an embodiment of the present invention;

FIG. 2 illustrates an example of a composite image displayed on a display portion;

FIG. 3 illustrates a composite image displayed on the display portion when a selection operation is performed to change a “selected aspect ratio” to 13:9;

FIG. 4 illustrates variations of composite image displayed on the display portion when selection operations are repetitively performed to repetitively change the “selected aspect ratio”;

FIG. 5 is a block diagram showing the specific configuration of an image display device according to an embodiment of the present invention;

FIG. 6 is a block diagram showing the internal structure of a marker combiner;

FIG. 7 is a timing chart showing the operation of the marker combiner;

FIG. 8 illustrates the internal structure of a switching unit;

FIGS. 9A and 9B show the relationship of a second timing signal with markers and auxiliary marks displayed on the display portion;

FIGS. 10A and 10B show an example in which 3:4 markers, indicating the selected aspect ratio, are displayed as solid lines extending from the top to the bottom of the display portion, in which white (high luminance) and black (low luminance) alternately appear;

FIG. 11 shows the internal structure of a timing generator;

FIG. 12 is a timing chart showing horizontal timing signals generated by the timing generator;

FIG. 13 is a truth table of a decoder;

FIG. 14 is a timing chart showing vertical timing signals generated by the timing generator:

FIG. 15 is a list of names, descriptions of functions, and generation sources of signals in the timing generator;

FIG. 16 is a list of names, descriptions of functions, and generation sources of signals in the timing generator;

FIG. 17 shows the internal structure of an attribute setter;

FIG. 18 shows the internal structure of an R-attribute setter;

FIG. 19 shows the internal structure of a first attribute generator;

FIG. 20 shows the internal structure of a third attribute generator;

FIG. 21 shows the internal structure of a first attribute selector;

FIG. 22 shows the internal structure of a data ON-OFF unit;

FIG. 23 is a list of display types, aspect ratios, signals used in the display types, and attribute values extracted by the signals;

FIG. 24 is a list of specific examples of attribute values set to the R-attribute setter, a G-attribute setter, and a B-attribute setter; and

FIG. 25 is a list of other specific examples of attribute values set to the R-attribute setter, the G-attribute setter, and the B-attribute setter.

### DESCRIPTION OF THE PREFERRED EMBODIMENTS

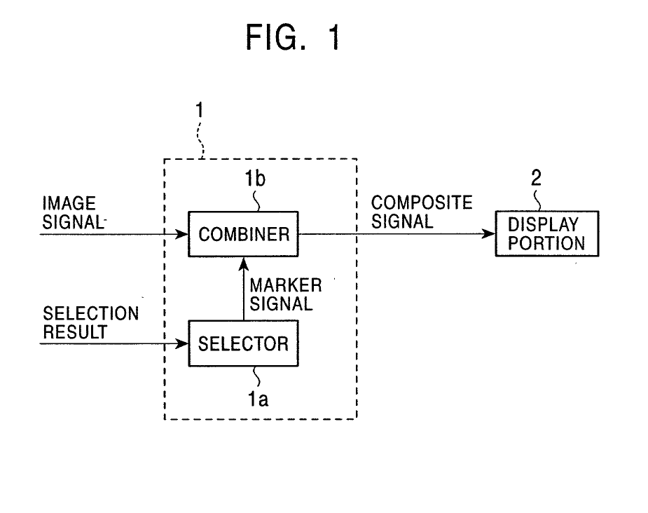

FIG. 1 is a block diagram showing the fundamental configuration of an image display device, for use in a television camera, according to an embodiment of the present invention. The image display device includes a marker combiner 1 for superimposing markers on an image and for creating a composite image and a display portion 2 for displaying the composite image. The marker combiner 1 includes a selector la for selecting markers and a combiner lb for superimposing the selected markers on the image.

An image signal input to the image display device is input to the combiner 1b. At the same time, the result of a selection operation performed by a user is input to the selector 1a. In accordance with the selection result, the selector 1a outputs a predetermined marker signal, and the marker signal is input to the combiner 1b. The combiner 1b combines the image signal and the marker signal to create a composite signal. The combiner 1b outputs the composite signal to the display portion 2, and the display portion 2 displays a composite image created by superimposing the markers on the image.

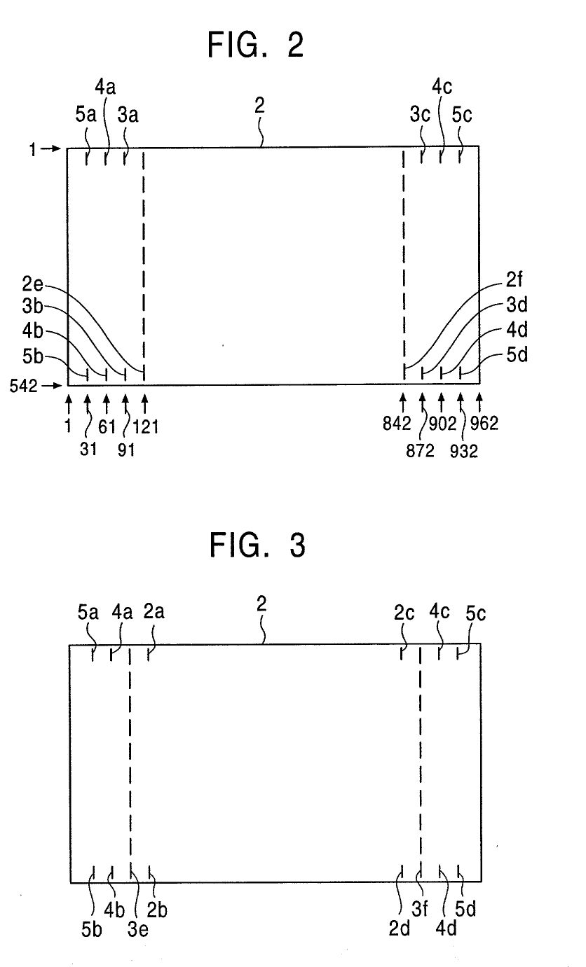

FIG. 2 shows an example of a composite image displayed on the display portion 2. Referring to FIG. 2, an active matrix liquid crystal display formed by 542 scanning lines and 962 vertical lines is shown, and an aspect ratio of 4:3 is selected. In the display portion 2, 4:3 markers 2e and 2f indicating a region with an aspect ratio of 4:3 are displayed at positions at which X=121 and X=842, respectively, wherein X represents a horizontal coordinate in the display portion 2 and the number represents the number of lines from the left of the display portion 2 as a reference point. Hereinafter X is used in the same sense. The 4:3 marker 2e and the 4:3 marker 2f are displayed at symmetric positions with respect to the center of the display portion 2. The 4:3 markers 2e and 2f are broken lines extending from the top to the bottom of the display portion 2.

Although the 4:3 markers 2e and 2f are broken lines in this example, they can be solid lines or dotted and dashed lines, or they can be opaque lines (image underneath the lines cannot be seen) or transparent lines (image underneath the lines can be seen).

The display portion 2 displays the 4:3 markers 2e and 2f; 13:9 auxiliary marks 3a, 3b, 3c, and 3d; 14:9 auxiliary marks 4a, 4b, 4c, and 4d; and 15:9 auxiliary marks 5a, 5b, 5c, and 5d. The 13:9 auxiliary marks 3a and 3b are displayed at positions where X=91. The 13:9 auxiliary marks 3c and 3d are displayed at positions where X=872. The 14:9 auxiliary marks 4a and 4b are displayed at positions where X=61. The 14:9 auxiliary marks 4c and 4d are displayed at positions where X=902. The 15:9 auxiliary marks 5a and 5b are displayed at positions where X=31. The 15:9 auxiliary marks 5c and 5d are displayed at positions where X=932. These auxiliary marks are solid lines which are shorter than the 4:3 markers 2e and 2f and which are displayed near the top and the bottom of the display portion 2. In other words, the auxiliary marks near the top are not continuous with the auxiliary marks near the bottom. For example, the 13:9 auxiliary mark 3a near the top is not continuous with the 13:9 auxiliary mark 3b near the bottom.

It is preferable that the auxiliary marks be as short as possible, within the range of perception, in order not to obstruct the image. Also, the auxiliary marks have different length, type, luminance, color, and transparency from the 4:3 markers 2e and 2f. The auxiliary marks need not be lines. For example, the auxiliary marks can be arrows or triangular marks.

As described above, the 4:3 markers 2e and 2f indicating the selected aspect ratio clearly differ from the auxiliary marks indicating the unselected aspect ratios. Therefore, the user can easily recognize that the selected aspect ratio is 4:3. The user can correctly recognize a region with the selected aspect ratio and recognize regions with the unselected aspect ratios.

FIG. 3 shows a composite image displayed on the display portion 2 when a selection operation is performed to change the “selected aspect ratio” to 13:9. The display portion 2 displays 13:9 markers 3e and 3f indicating a region with an aspect ratio of 13:9; 4:3 auxiliary marks 2a, 2b, 2c, and 2d; the 14:9 auxiliary marks 4a, 4b, 4c, and 4d; and the 15:9 auxiliary marks 5a, 5b, 5c, and 5d. The 4:3 auxiliary marks 2a and 2b are displayed at positions where X=121. The 4:3 auxiliary marks 2c and 2d are displayed at positions where X=842. The 13:9 markers 3e and 3f are displayed at positions where X=91 and X=872, respectively. Specifically, for 4:3, the 4:3 markers 2e and 2f are changed to the 4:3 auxiliary marks 2a to 2d. For 13:9, the 13:9 auxiliary marks 3a to 3d are changed to the 13:9 markers 3e and 3f.

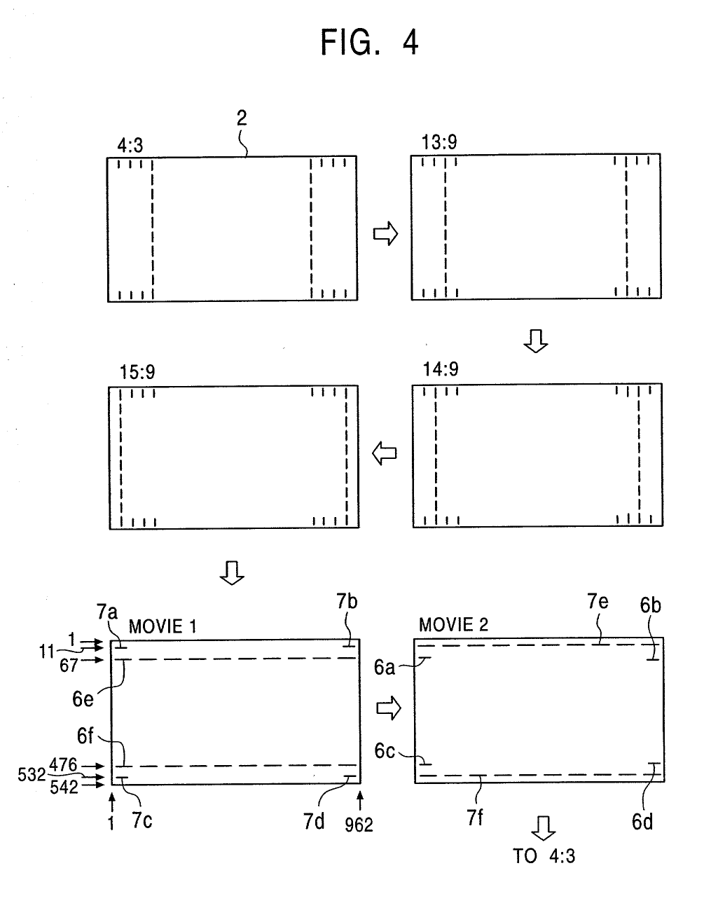

FIG. 4 shows variations of composite image displayed on the display portion 2 when selection operations are repetitively performed to repetitively change the “selected aspect ratio”. When selection operations are repetitively performed, the “selected aspect ratio” is changed to 4:3, 13:9, 14:9, 15:9, movie 1, and movie 2 in this order.

The movie 1 and the movie 2 are aspect ratios for movies. In these cases, broken lines extending from the left side to the right side of the display portion 2 and auxiliary marks parallel to these broken lines are displayed. Specifically, when the movie 1 is selected, movie 1 markers 6e and 6f which are broken lines extending from the left side to the right side of the display portion 2 and movie 2 auxiliary marks 7a, 7b, 7c, and 7d are displayed. When the movie 2 is selected, movie 2 markers 7e and 7f which are broken lines extending from the left side to the right side of the display portion 2 and movie 1 auxiliary marks 6a, 6b, 6c, and 6d are displayed. The movie 1 markers 6e and 6f are displayed at positions where Y=67 and Y=476, respectively, wherein Y represents a vertical coordinate in the display portion 2 and the number represents the number of scanning lines from of the top of the display portion 2 as a reference point. Hereinafter Y is used in the same sense. The movie 2 auxiliary marks 7a and 7b are displayed at positions where Y=11, and the movie 2 auxiliary marks 7c and 7d are displayed at positions where Y=532. The movie 2 markers 7e and 7f are displayed at positions where Y=11 and Y=532, respectively. The movie 1 auxiliary marks 6a and 6b are displayed at positions where Y=67, and the movie 1 auxiliary marks 6c and 6d are displayed at positions where Y=476.

For example, when the user wants to accurately confirm the boundary of the region with each aspect ratio, the user can perform the foregoing operation. In accordance with the markers indicating the “selected aspect ratio”, the user can accurately confirm the boundary near the center of the display portion 2, which is difficult to detect using the auxiliary marks. Since the auxiliary marks indicating the unselected aspect ratios other than the “selected aspect ratio” are also displayed, the user never loses references to the unselected aspect ratios.

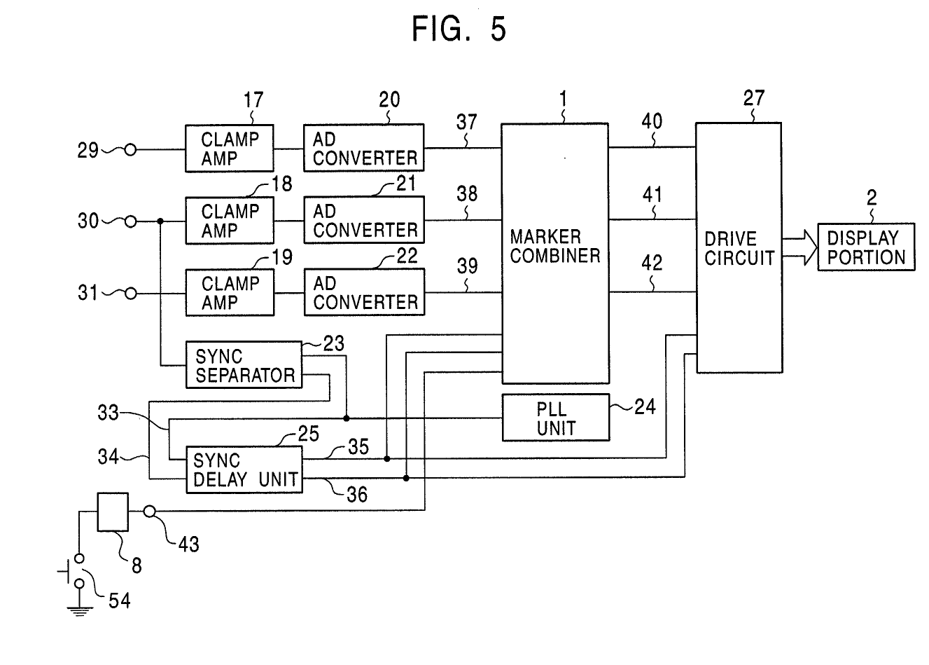

FIG. 5 is a block diagram showing the specific configuration of an image display device according to an embodiment of the present invention. Clamp amplifiers 17, 18, and 19 respectively receive an R signal 29, a G signal 30, and a B signal 31 for forming an image signal, and perform amplification with reference to a pedestal level of each signal.

The signals amplified by the clamp amplifiers 17, 18, and 19 are input to AD converters 20, 21, and 22, respectively, and the amplified signals are converted into a digital R signal 37, a digital G signal 38, and a digital B signal 39, respectively. The digital R signal 37, the digital G signal 38, and the digital B signal 39 are input to the marker combiner 1, and they are combined with a marker signal. The marker combiner 1 outputs composite signals, namely, a marker composite R signal 40, a marker composite G signal 41, and a marker composite B signal 42. The marker composite R signal 40, the marker composite G signal 41, and the marker composite B signal 42 are input to a drive circuit 27. In accordance with these signals, the drive circuit 27 drives the display portion 2 and causes the display portion 2 to display a composite image.

In this embodiment, a sync signal is superimposed on the G signal 30. The G signal 30 is input to a sync separator 23. The sync separator 23 separates the G signal 30 into a horizontal sync signal 33 and a vertical sync signal 34. The horizontal sync signal 33 is input to a PLL (Phase-Locked Loop) unit 24, and the PLL unit 24 generates a system clock. Although the system clock is input to each portion shown in FIG. 5, the system clock is not shown in FIG. 5 in order to simplify the drawing.

The horizontal sync signal 33 is also input to a sync delay unit 25. The vertical sync signal 34 is also input to the sync delay unit 25. The sync delay unit 25 delays the horizontal sync signal 33 and the vertical sync signal 34 for the time required for the clamp amplifiers 17, 18, and 19 and the AD converters 20, 21, and 22 to perform processing, and outputs a delayed horizontal sync signal 35 and a delayed vertical sync signal 36. The delayed horizontal sync signal 35 and the delayed vertical sync signal 36 are input to the marker combiner 1 and are used as timing references for combining markers. On the basis of the references, the marker combiner 1 determines horizontal and vertical positions at which the markers are displayed. The delayed horizontal sync signal 35 and the delayed vertical sync signal 36 are input to the drive circuit 27 and are used as timing references for the drive circuit 27 to drive the display portion 2.

The marker combiner 1 receives the above-described delayed horizontal sync signal 35, the delayed vertical sync signal 36 , the digital R signal 37, the digital G signal 38, and the digital B signal 39 and outputs the marker composite R signal 40, the marker composite G signal 41, and the marker composite B signal 42. Also the marker combiner 1 receives a marker switching signal 43 and changes the type of marker.

The marker switching signal 43 is supplied from a CPU (Central Processing Unit) 8. A tact switch 54 is connected to the CPU 8. Every time the tact switch 54 is turned ON, the CPU 8 sequentially changes the marker switching signal 43. Accordingly, compared with a case in which the marker switching signal 43 is changed using mechanical toggle switches or digital switches, the marker switching signal 43 can be changed by fewer switches. Thus, the marker can be changed by a few switches.

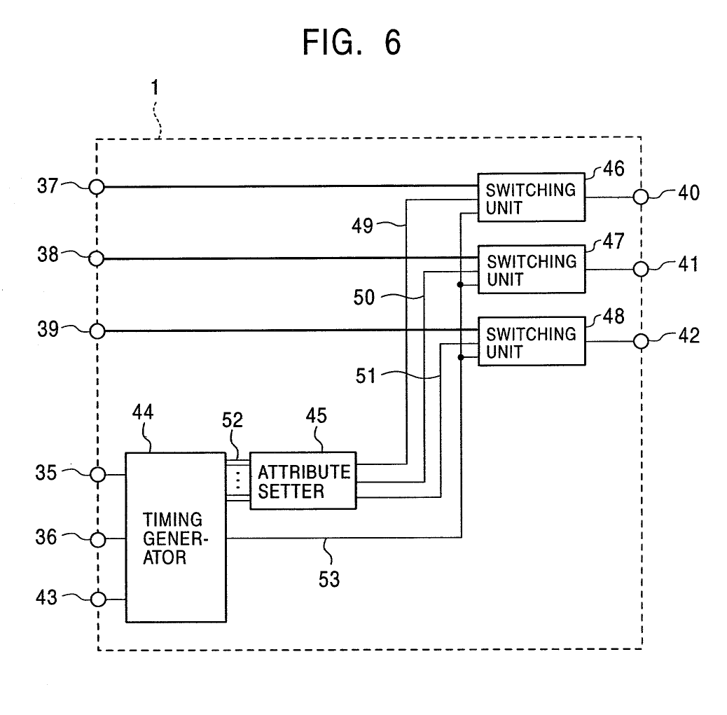

FIG. 6 is a block diagram showing the internal structure of the marker combiner 1. The marker combiner 1 includes a timing generator 44, an attribute setter 45, and switching units 46, 47, and 48. The timing generator 44 receives the delayed horizontal sync signal 35, the delayed vertical sync signal 36, and the marker switching signal 43 and outputs a first timing signal 52. The first timing signal 52 defines the times at which the markers and the auxiliary marks are displayed. The first timing signal 52 is input to the attribute setter 45. The attribute setter 45 sets display attributes of the markers and the auxiliary marks and outputs an attribute setting R signal 49, an attribute setting G signal 50, and an attribute setting B signal 51.

The attribute setting R signal 49, the attribute setting G signal 50, and the attribute setting B signal 51 are input to the switching units 46, 47, and 48, respectively. A second timing signal 53 output from the timing generator 44 is also input to the switching units 46, 47, and 48. The second timing signal 53 is generated on the basis of the delayed horizontal sync signal 35 and the delayed vertical sync signal 36 and defines the times at which the switching units 46, 47, and 48 switch the input signal. Specifically, for the switching unit 46, the second timing signal 53 defines the time at which the digital R signal 37 is switched to the attribute setting R signal 49 and vice versa. For the switching unit 47, the second timing signal 53 defines the time at which the digital G signal 38 is switched to the attribute setting G signal 50 and vice versa. For the switching unit 48, the second timing signal 53 defines the time at which the digital B signal 39 is switched to the attribute setting B signal 51 and vice versa.

The switching units 46, 47, and 48 each selectively output one of the two input signals which are input thereto at the time defined by the second timing signal 53. Specifically, the switching unit 46 outputs the digital R signal 37 or the attribute setting R signal 49 as the marker composite R signal 40. The switching unit 47 outputs the digital G signal 38 or the attribute setting G signal 50 as the marker composite G signal 41. The switching unit 48 outputs the digital B signal 39 or the attribute setting B signal 51 as the marker composite B signal 42.

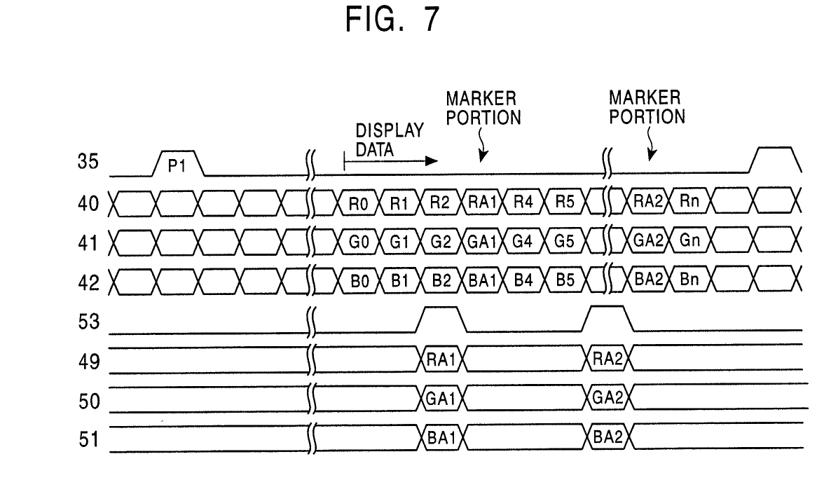

FIG. 7 is a timing chart showing the operation of the marker combiner 1. The number of clocks from the time at which a pulse P1 of the delayed horizontal sync signal 35 is input to the time at which display data is output as the marker composite R signal 40, the marker composite G signal 41, and the marker composite B signal 42 is predetermined. For example, a marker can be displayed at the fourth pixel from the left side of each scanning line extending in the horizontal direction of the display portion 2 by outputting, from the timing generator 44, the first timing signal 52 two clocks prior to displaying the marker on the basis of the time at which the pulse P1 of the delayed horizontal sync signal 35 is input. Accordingly, the first timing signal 52 is input to the attribute setter 45, and the attribute setter 45 outputs RA1, GA1, and BA1 as the attribute setting R signal 49, the attribute setting G signal 50, and the attribute setting B signal 51, respectively, one clock prior to displaying the marker. Simultaneously, the timing generator 44 outputs the second timing signal 53.

The attribute setting R signal 49, the attribute setting G signal 50, and the attribute setting B signal 51 are input to the switching units 46, 47, and 48, respectively. At the same time, the second timing signal 53 is input to the switching units 46, 47, and 48. In response, the switching units 46, 47, and 48 switch the signal to be selected when the marker is displayed. Specifically, the switching unit 46 switches the signal to be selected from the digital R signal 37 to the attribute setting R signal 49 when the marker is displayed. The switching unit 47 switches the signal to be selected from the digital G signal 38 to the attribute setting G signal 50 when the marker is displayed. The switching unit 48 switches the signal to be selected from the digital B signal 39 to the attribute setting B signal 51 when the marker is displayed. The switched signals are output as the marker composite R signal 40, the marker composite G signal 41, and the marker composite B signal 42.

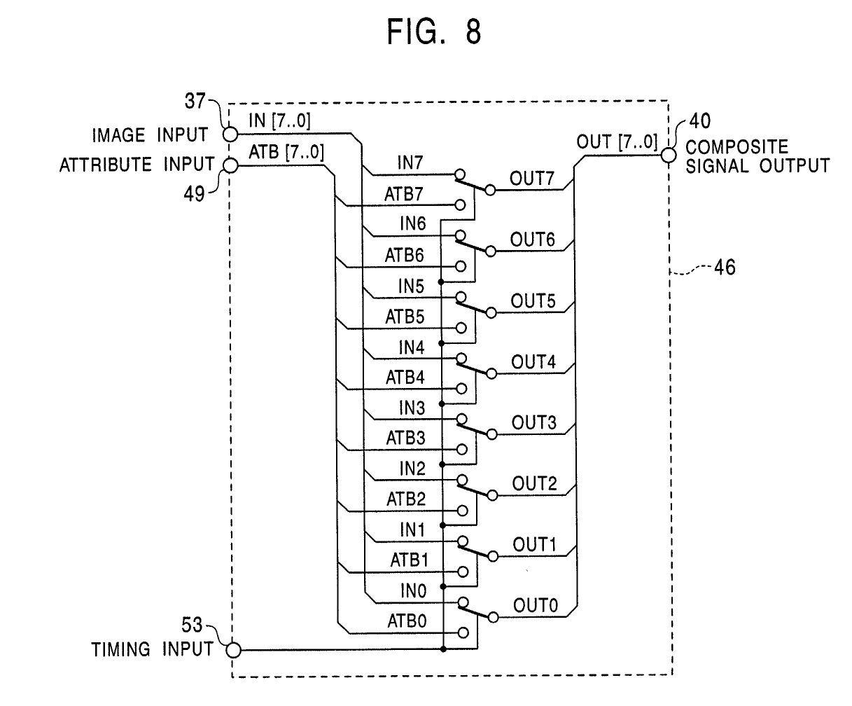

FIG. 8 shows the internal structure of the switching unit 46. Since the internal structure of each of the switching units 47 and 48 is the same as that of the switching unit 46, descriptions thereof are omitted. The switching unit 46 receives the digital R signal 37 which is an 8-bit parallel signal and the attribute setting R signal 49 which is also an 8-bit parallel signal, selects one of the two signals, and outputs the selected signal as the marker composite R signal 40. The selection is determined by the second timing signal 53. Specifically, when the pulse of the second timing signal 53 is not input (that is, when the second timing signal 53 is at a low level), the digital R signal 37 is selected. When the pulse of the second timing signal 53 is input (that is, when the second timing signal 53 is at a high level), the attribute setting R signal 49 is selected.

In the structure shown in FIG. 8, all the bits of the digital R signal 37 are switched to all the bits of the attribute setting R signal. In order to make the marker opaque, only some of the bits are switched. For example, switches connected to OUT7, OUT6, OUTS, and OUT4 are switched, and switches connected to OUT3, OUT2, OUT1, and OUTO are not switched (the switches are fixed to a state in which the digital R signal 37 is selected).

In the structure shown in FIG. 8, the switching unit 46 is formed by switches. Instead of the switches, the switching unit 46 can be formed by a combination of AND gates and OR gates.

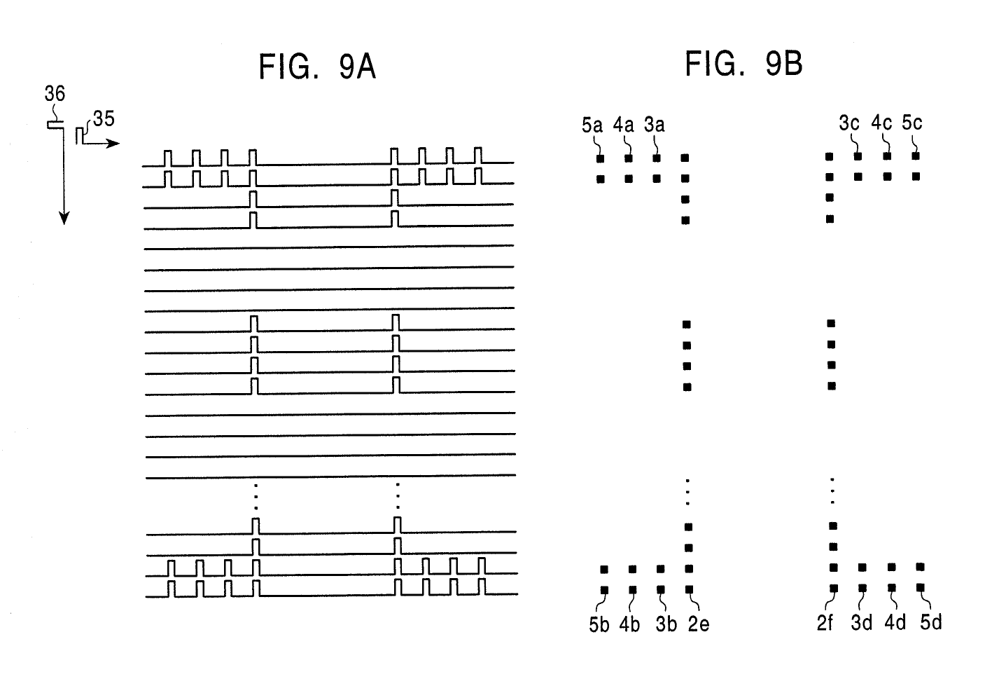

FIGS. 9A and 9B show the relationship of the second timing signal 53 with the markers and the auxiliary marks displayed on the display portion 2. FIG. 9A shows waveforms of the second timing signal 53 on scanning lines extending in the horizontal direction of the display portion 2. FIG. 9B shows images of the markers and the auxiliary marks displayed on the display portion 2 in accordance with the waveforms. Positions of pixels at which the markers and the auxiliary marks are displayed are determined by the time at which the pulse of the second timing signal 53 is output. More specifically, the horizontal position is determined by the time based on the delayed horizontal sync signal 35, and the vertical position is determined by the time based on the delayed vertical sync signal 36 (that is, the scanning line on which the auxiliary mark/marker is displayed). In the example shown in FIGS. 9A and 9B, the 3:4 markers 2e and 2f indicating the selected aspect ratio are displayed as broken lines extending from the top to the bottom of the display portion 2. The 13:9 auxiliary marks 3a to 3d, the 14:9 auxiliary marks 4a to 4d, and the 15:9 auxiliary marks 5a to 5d indicating the unselected aspect ratios are displayed as solid lines each having a length of two scanning lines (two pixels).

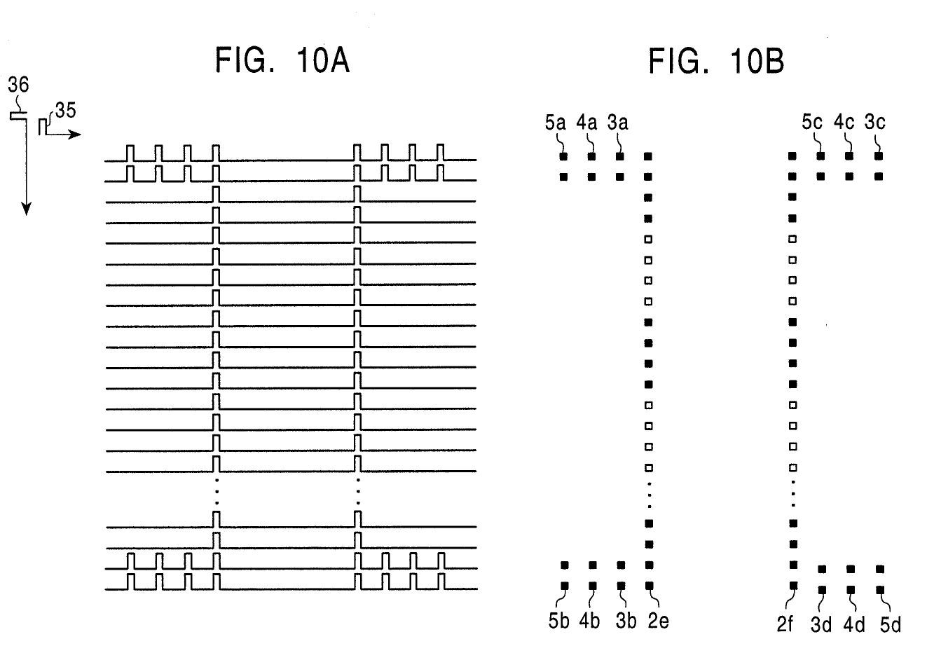

FIGS. 10A and 10B show an example in which the 3:4 markers 2e and 2f, indicating the selected aspect ratio, are displayed as solid lines extending from the top to the bottom of the display portion 2, in which white (high luminance) and black (low luminance) alternately appear. When displaying white (high luminance) pixels of the 3:4 markers 2e and 2f, maximum values (FFh) of the attribute setting R signal 49, the attribute setting G signal 50, and the attribute setting B signal 51 are output. When displaying black (low luminance) pixels, minimum values (OOh) of the attribute setting R signal 49, the attribute setting G signal 50, and the attribute setting B signal 51 are output.

As described above, according to the image display device of the present invention, the markers and the auxiliary markers indicating a plurality of aspect ratios are simultaneously displayed on the display portion 2. The user can reliably recognize the current aspect ratio being selected. Unlike indicating an aspect ratio using numerals, the user has no difficulty in viewing the displayed image. Since it is unnecessary to provide an additional auxiliary display or an LED in the casing, which is a different screen from that displaying the image, the size of the image display device is not increased.

According to the image display device of the present invention, the markers and the auxiliary marks can be displayed using simple waveforms. Even when the “selected aspect ratio” is switched and the positions of the markers are changed, or even when a plurality of marker types and auxiliary mark types is prepared, the circuit configuration is simple. It is unnecessary to provide a ROM (Read Only Memory), which is necessary for transmitting character data. The circuit can be formed using a combinational simple logic circuit (circuit combining basic gates) and a sequential logic circuit (flip flop circuit or the like). Thus, the size and the cost of the image display device can be reduced.

Although the image signal and the marker signal are digital signals in the foregoing embodiment, the present invention is not limited to this embodiment. For example, the image signal and the marker signal can be analog signals. In such a case, the digital R signal 37, the digital G signal 38, the digital B signal 39, the attribute setting R signal 49, the attribute setting G signal 50, and the attribute setting B signal 51 are replaced with voltage values, and the switching units 46, 47, and 48 are replaced with analog switches.

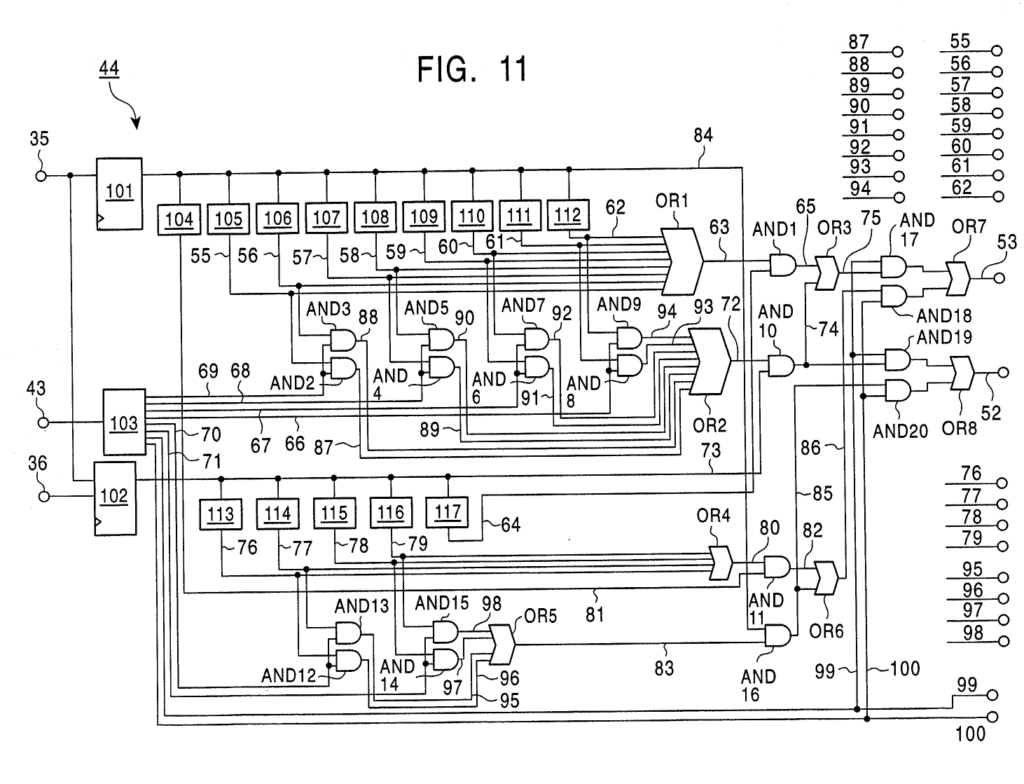

FIG. 11 shows the internal structure of the timing generator 44. As described above, the timing generator 44 receives the delayed horizontal sync signal 35, the delayed vertical sync signal 36, and the marker switching signal 43 and outputs the first timing signal 52 and the second timing signal 53. Also, the timing generator 44 outputs signals 55 to 62, 87 to 94, 76 to 79, and 95 to 100 for performing setting by the attribute setter 44.

The delayed horizontal sync signal 35 is input to a counter 101 and resets a counter value in the counter 101. The counter value in the counter 101 is incremented every time the system clock is input thereto. The output of the counter 101 is input to decoders 104 to 112.

The delayed vertical sync signal 36 is input to a counter 102 and resets a counter value in the counter 102. The counter value in the counter 102 is incremented every time the system clock is input thereto. The output of the counter 102 is input to decoders 113 to 117.

A timing generating method for the 15:9 auxiliary marks, the 14:9 auxiliary marks, the 13:9 auxiliary marks, and the 4:3 auxiliary marks will now be described.

When the counter value in the counter 101 reaches a predetermined value, the decoder 105 outputs the signal 55 indicating the horizontal timing of the 15:9 left auxiliary mark. When the counter value in the counter 101 reaches a predetermined value, the decoder 106 outputs the signal 56 indicating the horizontal timing of the 15:9 right auxiliary mark.

When the counter value in the counter 101 reaches a predetermined value, the decoder 107 outputs the signal 57 indicating the horizontal timing of the 14:9 left auxiliary mark. When the counter value in the counter 101 reaches a predetermined value, the decoder 108 outputs the signal 58 indicating the horizontal timing of the 14:9 right auxiliary mark.

When the counter value in the counter 101 reaches a predetermined value, the decoder 109 outputs the signal 59 indicating the horizontal timing of the 13:9 left auxiliary mark. When the counter value in the counter 101 reaches a predetermined value, the decoder 110 outputs the signal 60 indicating the horizontal timing of the 13:9 right auxiliary mark.

When the counter value in the counter 101 reaches a predetermined value, the decoder 111 outputs the signal 61 indicating the horizontal timing of the 4:3 left auxiliary mark. When the counter value in the counter 101 reaches a predetermined value, the decoder 112 outputs the signal 62 indicating the horizontal timing of the 4:3 right auxiliary mark.

The signals 55 to 62 are input to an OR gate (OR1) and the OR gate (OR1) outputs a signal 63 indicating the logical OR of the signals 55 to 62. Specifically, the signal 63 is repeatedly output every time the delayed horizontal sync signal 35 is input.

In this state, continuous lines extending from the top to the bottom of the display portion 2 are displayed at boundaries of sections with aspect ratios of 15:9, 14:9, 13:9, and 4:3. Each line is displayed from a position adjacent to the top of the display portion 2 to a first predetermined position. Each line is not displayed from the first predetermined position to a second predetermined position therebelow. Each line is displayed from the second predetermined position to a position adjacent to the bottom of the display portion 2. In order to do so, an AND gate (AND1) computes the logical AND of the signal 63 and a signal 64 output from the decoder 117. Thus, the signal 64 applies a mask to the signal 63.

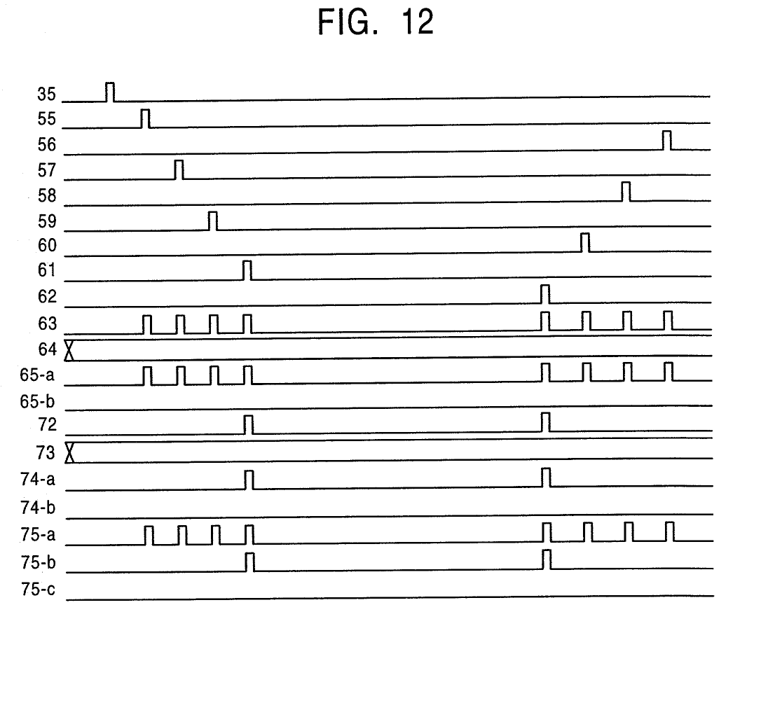

FIG. 12 is a timing chart showing horizontal timing signals generated by the timing generator 44. The waveforms of the signals 55 to 62, the signal 63 indicating the logical OR of the signals 55 to 62, the signal 64 for applying a mask, and a signal 65 output by the AND gate (AND1) are shown. Specifically, when displaying a line on the display portion 2 (that is, when the signal 64 is at a high level), the signal 65 has a waveform 65-a shown in FIG. 12. When not displaying a line (that is, when the signal 64 is at a low level), the signal 65 has a waveform 65-b. In accordance with the waveforms, each auxiliary mark is indicated by two lines which are displayed near the top and the bottom of the display portion 2. Each auxiliary mark is not a continuous line extending from the top to the bottom of the display portion 2.

A timing generation method for the 15:9 markers, the 14:9 markers; the 13:9 markers, and the 4:3 markers will now be described.

As described above, the decoders 105 and 106 generate the signals 55 and 56 indicating the horizontal timing corresponding to the boundary of the section with an aspect ratio of 15:9. The decoders 107 and 108 generate the signals 57 and 58 indicating the horizontal timing corresponding to the boundary of the section with an aspect ratio of 14:9. The decoders 109 and 110 generate the signals 59 and 60 indicating the horizontal timing corresponding to the boundary of the section with an aspect ratio of 13:9. The decoders 111 and 112 generate the signals 61 and 62 indicating the horizontal timing corresponding to the boundary of the section with an aspect ratio of 4:3.

In order to select one from the above four pairs of signals, the decoder 103 outputs selection signals 69, 68, 67, and 66. In accordance with the marker switching signal 43, the decoder 103 outputs the selection signals 69, 68, 67, and 66.

An AND gate (AND2) computes the logical AND of the signals 69 and 55; an AND gate (AND3) computes the logical AND of the signals 69 and 56; an AND gate (AND4) computes the logical AND of the signals 68 and 57; an AND gate (AND5) computes the logical AND of the signals 68 and 58; an AND gate (AND6) computes the logical AND of the signals 67 and 59; an AND gate (AND7) computes the logical AND of the signals 67 and 60; an AND gate (AND8) computes the logical AND of the signals 66 and 61; and an AND gate (AND9) computes the logical AND of the signals 66 and 62. Then, the AND gates (AND2 to AND9) output the signals 87, 88, 89, 90, 91, 92, 93, and 94, respectively.

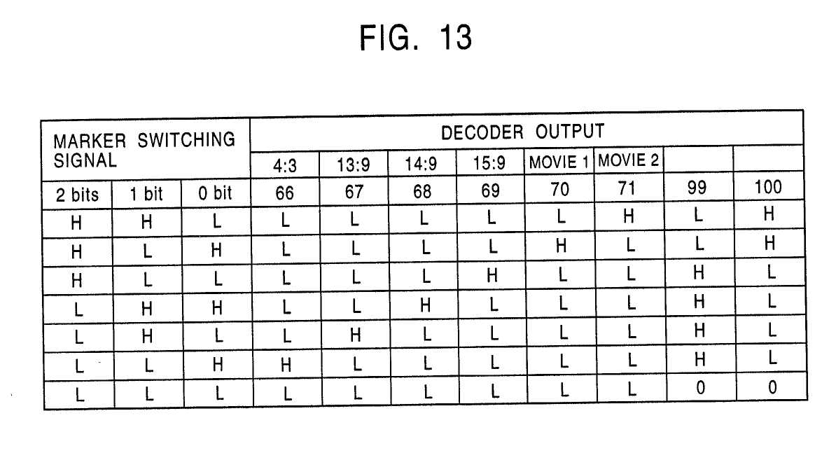

FIG. 13 is a truth table of the decoder 103. Specifically, the signals 69, 68, 67, and 66 output by the decoder 103 are such that only one signal is H (at high level) or all the signals are L (at low level). For example, when the signal 66 is H, only the signals 93 and 94, that is, the signals indicating timing corresponding to an aspect ratio of 4:3, are output. The signals 87 and 88, the signals 89 and 90, and the signals 91 and 92 corresponding to the other aspect ratios are not output (fixed to L). The signals 87 and 88, the signals 89 and 90, the signals 91 and 92, and the signals 93 and 94 are input to an OR gate (OR2), and the OR gate (OR2) computes the logical OR of the input signals. A signal 72 output from the OR gate (OR2) indicates timing corresponding an aspect ratio of 4:3.

The signal 72 is repeatedly output every time the delayed horizontal sync signal 35 is input. In other words, in this state, a solid continuous line extending from the top to the bottom of the display portion 2 is displayed on the boundary of the section with an aspect ratio of 4:3. In this embodiment, the 4:3 marker is to be displayed as a broken line. The line is alternately displayed and not displayed from a position adjacent to the top of the display portion 2 to a position adjacent to the bottom of the display portion 2. To do so, an AND gate (AND10) computes the logical AND of the signal 72 and a signal 73 which is a first bit of the counter value output by the counter 102 (least significant bit (LSB) is a zeroth bit). Thus, the signal 73 applies a mask to the signal 72. As a result, a signal 74 output from the AND gate (AND10) alternately has a waveform 74-a and a waveform 74-b shown in FIG. 12 every four horizontal scanning lines in the display portion 2. In accordance with the waveforms, the 4:3 marker becomes a broken line extending from the top to the bottom of the display portion 2.

The same applies to the 15:9 marker, the 14:9 marker, and the 13:9 marker. In accordance with the marker switching signal 43 corresponding to each aspect ratio, the decoder 103 sets the signals 69, 68, 67, and 66 and generates a timing signal corresponding to each aspect ratio.

By changing the output pattern of the decoder 103, it is possible to generate a timing signal corresponding to a plurality of aspect ratios. Accordingly, markers corresponding to a plurality of aspect ratios can be simultaneously displayed on the display portion 2.

The signal 65 indicating the timing of three auxiliary marks of the 15:9 auxiliary mark, the 14:9 auxiliary mark, the 13:9 auxiliary mark, and the 4:3 auxiliary mark and the signal 74 indicating the timing of one marker (e.g., the 4:3 marker) are input to an OR gate (OR3), and the OR gate (OR3) computes the logical OR of these signals. A signal 75 output from the OR gate (OR3) indicates both the timing of three auxiliary marks and the timing of one marker.

Depending on the vertical position on the display portion 2, the signal 75 has waveforms 75-a, 75-b, and 75-c shown in FIG. 12. Specifically, on a horizontal scanning line where both the auxiliary marks and the marker are displayed, the signal 75 has the waveform 75-a. On a horizontal scanning line where only the marker is displayed, the signal 75 has the waveform 75-b. On a horizontal scanning line where neither is displayed (that is, at a position at which a broken line indicating the marker is not displayed), the signal 75 has the waveform 75-c.

A timing generation method for the movie 2 auxiliary marks and the movie 1 auxiliary marks will now be described.

When the counter value in the counter 102 reaches a predetermined value, the decoder 113 outputs the signal 76 indicating the vertical timing of the movie 2 top auxiliary mark. When the counter value in the counter 102 reaches a predetermined value, the decoder 114 outputs the signal 77 indicating the vertical timing of the movie 2 bottom auxiliary mark.

When the counter value in the counter 102 reaches a predetermined value, the decoder 115 outputs the signal 78 indicating the vertical timing of the movie 1 top auxiliary mark. When the counter value in the counter 102 reaches a predetermined value, the decoder 116 outputs the signal 79 indicating the vertical timing of the movie 1 bottom auxiliary mark.

These signals 76 to 79 are input to an OR gate (OR4), and the OR gate (OR4) outputs a signal 80 indicating the logical OR of the signals 76 to 79. In other words, the signal 80 is repeatedly output every time the delayed vertical sync signal 36 is input.

In this state, continuous lines extending from the left side to the right side of the display portion 2 will be displayed at the boundaries of the movie 2 section and the movie 1 section. Each line is displayed from a position adjacent to the left side of the display portion 2 to a first predetermined position. Each line is not displayed from the first predetermined position to a second predetermined position which is on the right of the first predetermined position. Each line is displayed from the second predetermined position to a position adjacent to the right side of the display portion 2. In order to do so, an AND gate (AND11) computes the logical AND of the signal 80 and a signal 81 output from the decoder 104. Thus, the signal 81 applies a mask to the signal 80.

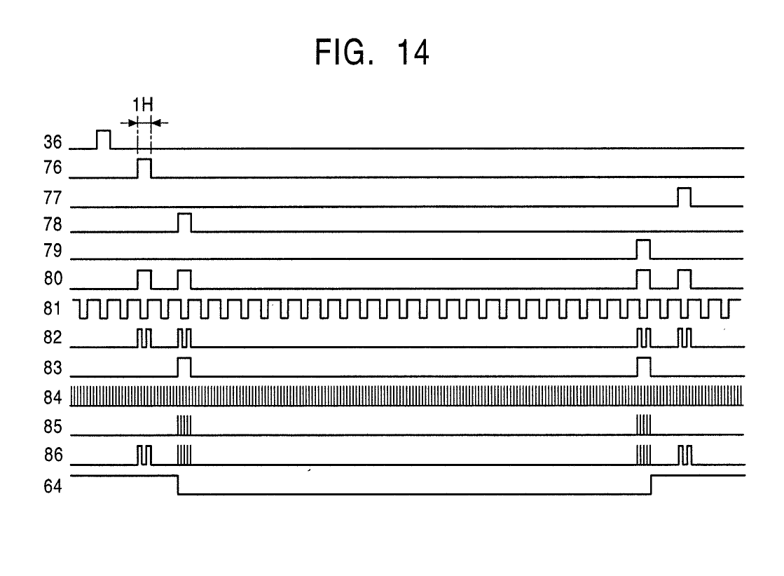

FIG. 14 is a timing chart showing vertical timing signals of the timing generator 44. In FIG. 14, the waveforms of the signals 76 to 79, the signal 80 indicating the logical AND of the signals 76 to 79, the signal 81 for masking the signal 80, and a signal 82 output from the AND gate (AND11) are shown. In accordance with the waveforms, each auxiliary mark is indicated by two lines which are displayed in the vicinity of the left side and the right side of the display portion 2. Each auxiliary mark is not indicated by a single continuous line extending from the left side to the right side of the display portion 2.

A timing generation method for the movie 2 markers and the movie 1 markers will now be described.

As described above, the decoders 113 and 114 generate the signals 76 and 77 indicating the vertical timing corresponding to the boundary of the movie 2 section, and the decoders 115 and 116 generate the signals 78 and 79 indicating the vertical timing corresponding to the boundary of the movie 1 section.

In order to select one from these two pairs of signals (a first pair includes the signals 76 and 77 and a second pair includes the signals 78 and 79), the decoder 103 outputs selection signals 70 and 71. In accordance with the marker switching signal 43, the decoder 103 outputs the selection signals 70 and 71.

An AND gate (AND12) computes the logical AND of the signals 70 and 76; an AND gate (AND13) computes the logical AND of the signals 70 and 77; an AND gate (AND14) computes the logical AND of the signals 71 and 78; and an AND gate (AND15) computes the logical AND of the signals 71 and 79. Then, the AND gates (AND12 to AND15) outputs the signals 95, 96, 97, and 98, respectively.

As described above, FIG. 13 shows the truth table of the decoder 103. Specifically, the signals 70 and 71 output from the decoder 103 are such that only one of the two signals is H (at high level) or both of the signals are L (at low level). When the signal 71 is H, the signals 97 and 98, that is, the signals indicating timing corresponding to the movie 1, are output, and the other signals 95 and 96 corresponding to the movie 2 are not output (specifically, fixed to L). The signals 95 and 96, and the signals 97 and 98 are input to an OR gate (OR5), and the OR gate (OR5) computes the logical OR of these input signals. A signal 83 output from the OR gate (OR5) is a signal indicating timing corresponding to the movie 1.

The signal 83 is repeatedly output every time the delayed vertical sync signal 36 is input. In this state, solid continuous lines extending from the left side to the right side of the display portion 2 will be displayed at the boundary of the movie 1 section. In this embodiment, the movie 1 markers are to be indicated by broken lines. Each line from a position adjacent to the left side of the display portion 2 to a position adjacent to the right side of the display portion 2 is alternately displayed and not displayed. In order to do so, an AND gate (AND16) computes the logical AND of the signal 83 and a signal 84 which is a second bit of the counter value output from the counter 101 (the LSB is a zeroth bit), and the signal 84 applies a mask to the signal 83. As a result, a signal 85 output from the AND gate (AND16) repeatedly becomes H and L every four vertical lines of the display portion 2. In accordance with the signal 85, the movie 1 markers become broken lines extending from the left side to the right side of the display portion 2.

The same applies to the movie 2 markers. In accordance with the marker switching signal 43 corresponding to the movie 2 markers, the decoder 103 sets the signals 70 and 71 and generates timing signals corresponding to the movie 2 markers.

The signal 82 indicating timing of one of the movie 2 auxiliary mark and the movie 1 auxiliary mark and the signal 85 indicating timing of a marker (e.g., the movie 1 marker) are input to an OR gate (OR6), and the OR gate (OR6) computes the logical OR of the signals 82 and 85. A signal 86 output from the OR gate (OR6) is a signal indicating both timing of the auxiliary mark and timing of the marker.

In this embodiment, when three auxiliary marks of the 15:9 auxiliary mark, the 14:9 auxiliary mark, the 13:9 auxiliary mark, and the 4:3 auxiliary mark and one marker of the 15:9 marker, the 14:9 marker, the 13:9 marker, and the 4:3 marker are displayed on the display portion 2, one of the movie 1 auxiliary mark and the movie 2 auxiliary mark and one of the movie 1 marker and the movie 2 marker are not displayed on the display portion 2. In contrast, when the movie 1/movie 2 auxiliary mark and marker are displayed, the 15:9, 14:9, 13:9, and 4:3 auxiliary marks and marker are not displayed. Also, the display portion 2 can be in a state in which no auxiliary mark nor marker is displayed. In order to achieve this state, the decoder 103 outputs the signals 99 and 100. The signal 99 is supplied to AND gates (AND17 and AND19), and the signal 100 is supplied to AND gates (AND18 and AND20). Truth tables of the signals 99 and 100 are illustrated in FIG. 13.

The signal 75 is input to the AND gate (AND17), and the signal 86 is input to the AND gate (AND18). The outputs of the AND gates (AND17 and AND18) are input to an OR gate (OR7), and the output of the OR gate (OR7) becomes the second timing signal 53.

The signal 74 is input to the AND gate (AND19), and the signal 85 is input to the AND gate (AND20). The outputs of the AND gates (AND19 and AND20) are input to an OR gate (OR8), and the output of the OR gate (OR8) becomes the first timing signal 52.

By changing the output pattern of the decoder 103, a timing signal corresponding to a plurality of aspect ratios (including 15:9, 14:9, 13:9, 4:3, movie 1, and movie 2) can be generated. Thus, auxiliary marks and markers corresponding to a plurality of aspect ratios can be simultaneously displayed on the display portion 2. For example, the 15:9 auxiliary marks, the 14:9 auxiliary marks, the 13:9 auxiliary marks, the 4:3 markers, the movie 2 auxiliary marks, and the movie 1 markers can be simultaneously displayed on the display portion 2.

As described above, in the timing generator 44, the circuit for generating the first timing signal 52 to be supplied to the attribute setter 45 and the second timing signal 53 to be supplied to the switching units 46, 47, and 48 is formed by basic gates including AND gates and OR gates and flip flops which form counters. It becomes unnecessary to use a ROM which has been conventionally required for transmitting character data. The circuit design of the timing generator 44 is simplified, and the circuit is miniaturized. This is advantageous in implementing circuit integration. Also, the cost of the circuit can be reduced.

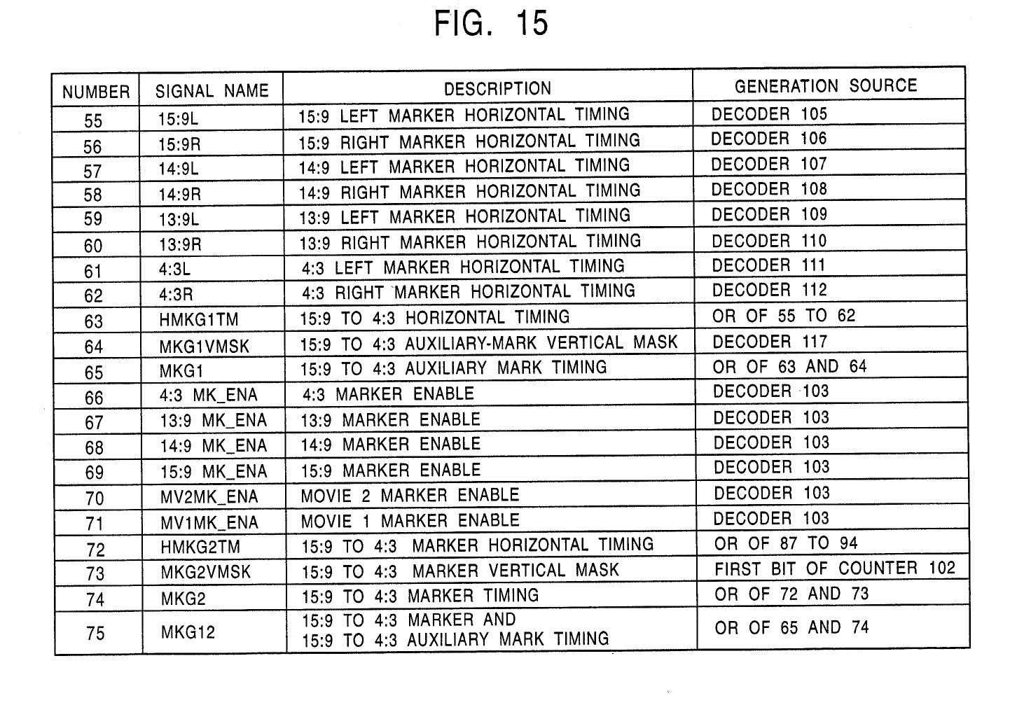

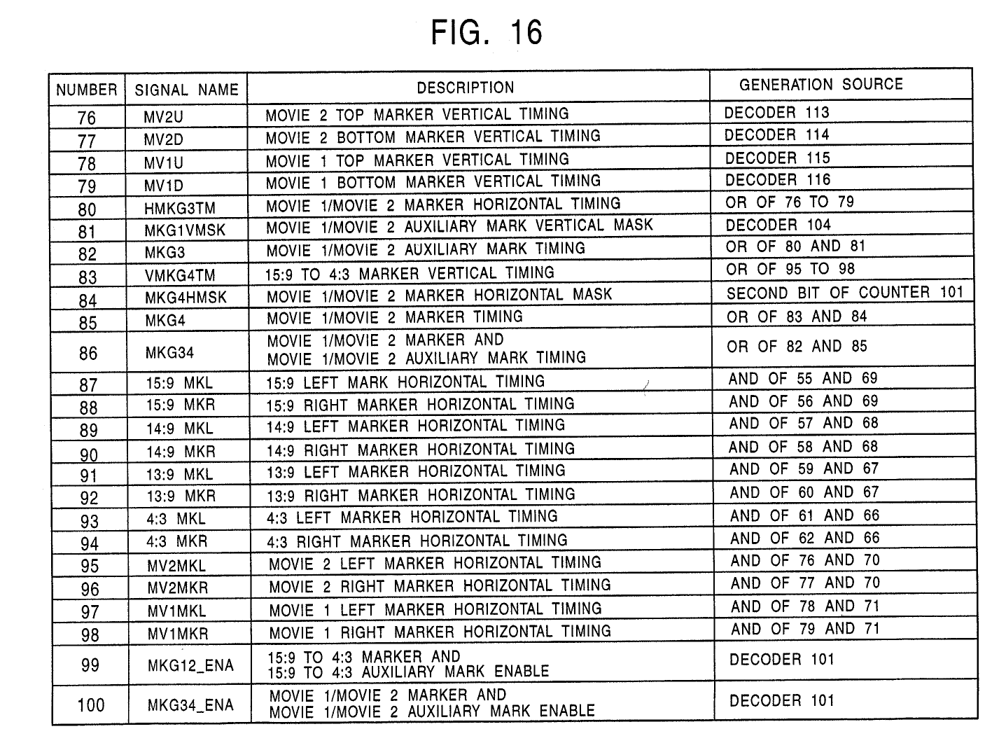

FIGS. 15 and 16 show lists of names of signals in the timing generator 44, descriptions of functions of the signals, and generation sources of the signals. These signals contribute to determination of the timing of the first timing signal 52 and the second timing signal 53.

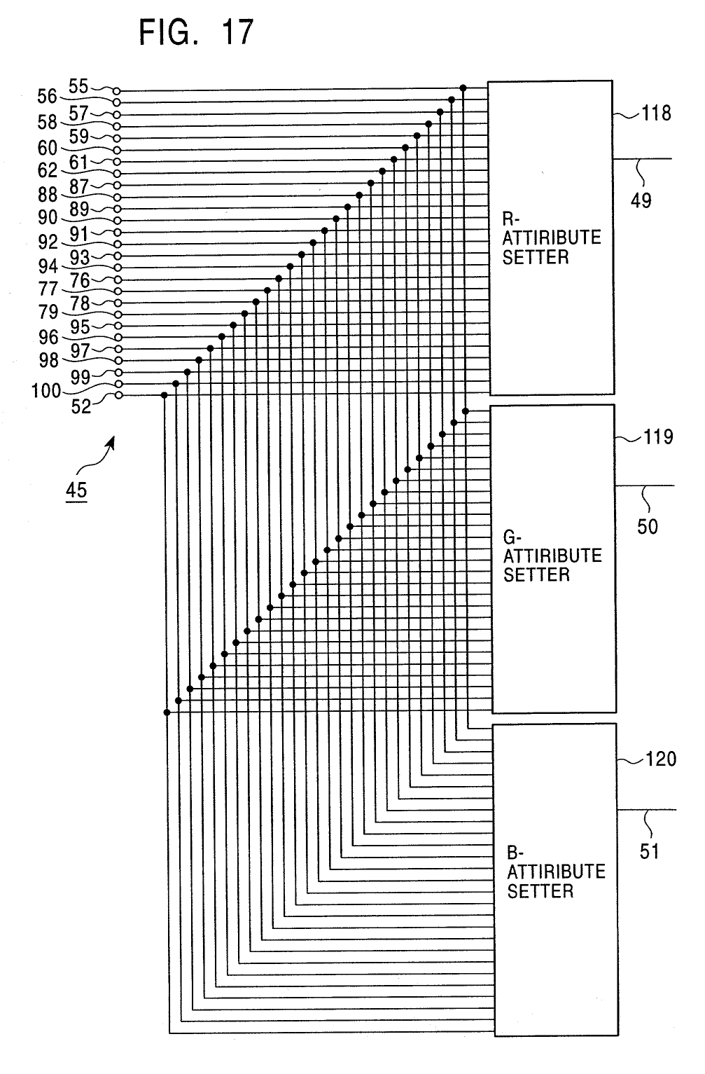

FIG. 17 shows the internal structure of the attribute setter 45. The attribute setter 45 receives the first timing signal 52, the signals 55 to 62, the signals 87 to 94, the signals 76 to 79, and the signals 95 to 100, which are output from the timing generator 44, and outputs the attribute setting R signal 49, the attribute setting G signal 50, and the attribute setting B signal 51.

The attribute setter 45 contains an R-attribute setter 118, a G-attribute setter 119, and a B-attribute setter 120. The R attribute setter 118, the G-attribute setter 119, and the B-attribute setter 120 each receive the first timing signal 52, the signals 55 to 62, the signals 87 to 94, the signals 76 to 79, and the signals 95 to 100. The R-attribute setter 118, the G-attribute setter 119, and the B-attribute setter 120 output the attribute setting R signal 49 indicating an attribute of R (red) component of a marker or auxiliary mark, the attribute setting G signal 50 indicating an attribute of G (green) component of a marker or auxiliary mark, and the attribute setting B signal 51 indicating an attribute of B (blue) component of a marker or auxiliary mark, respectively.

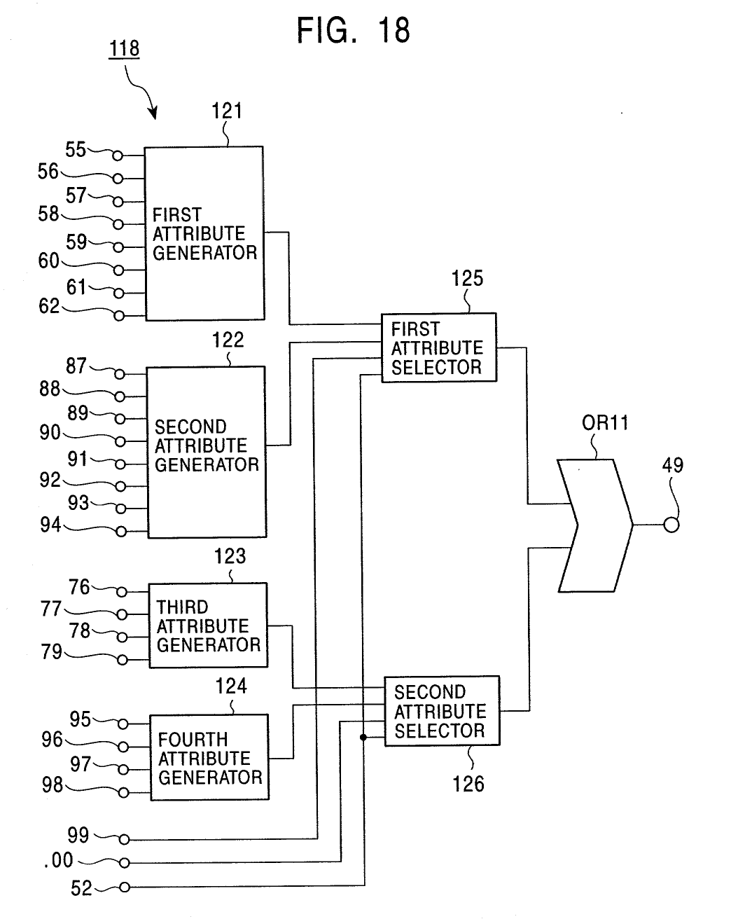

FIG. 18 shows the internal structure of the R-attribute setter 118. Since the internal structure of each of the G-attribute setter 119 and the B-attribute setter 120 is the same as that of the R-attribute setter 118, descriptions thereof are omitted.

The R-attribute setter 118 contains a first attribute generator 121 which receives the signals 55 to 62, a second attribute generator 122 which receives the signals 87 to 94, a third attribute generator 123 which receives the signals 76 to 79, and a fourth attribute generator 124 which receives the signals 95 to 98. The first attribute generator 121, the second attribute generator 122, the third attribute generator 123, and the fourth attribute generator 124 output attribute values (each value is a plurality of bits).

The R-attribute setter 118 also contains a first attribute selector 125, a second attribute selector 126, and an OR gate group (OR11). The first attribute selector 125 receives the attribute value output from the first attribute generator 121, the attribute value output from the second attribute generator 122, and the signal 99 and the first timing signal 52 from the timing generator 44. The second attribute selector 126 receives the attribute value output from the third attribute generator 123, the attribute value output from the fourth attribute generator 124, and the signal 100 and the first timing signal 52 from the timing generator 44. The attribute values output from the first attribute selector 125 and the second attribute selector 126 are input to the OR gate group (OR11). The OR gate group (OR11) is formed by the same number of OR gates as the number of bits of each attribute value. Each OR gate computes the logical OR of corresponding bits of the attribute value output from the first attribute selector 125 and the attribute value output from the second attribute selector 126. The attribute values output from the OR gate group (OR11) become the attribute setting R signal 49.

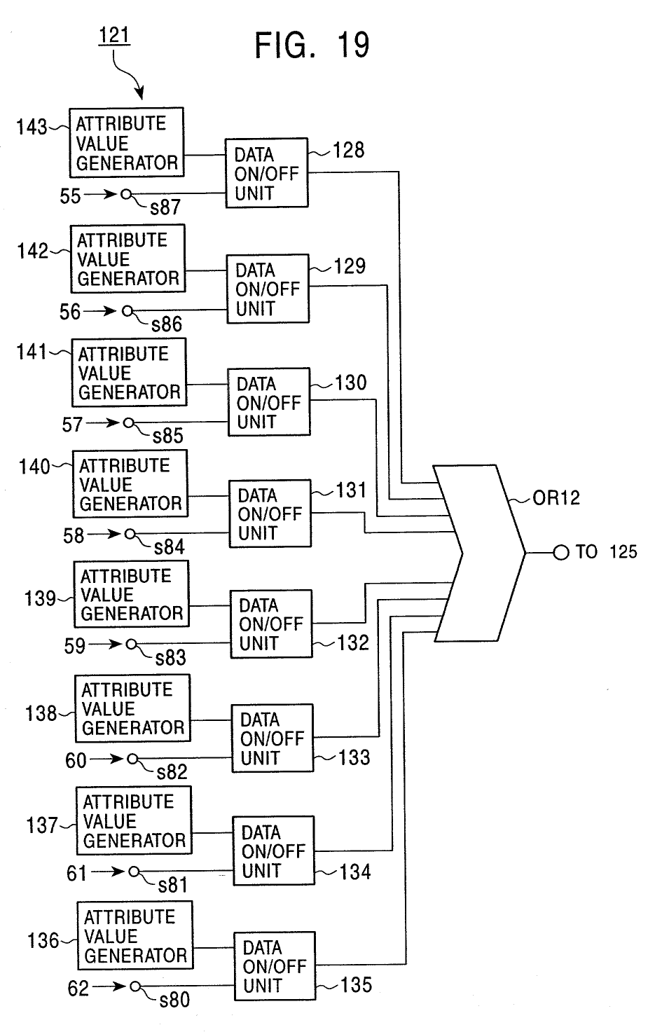

FIG. 19 shows the internal structure of the first attribute generator 121. Since the internal structure of the second attribute generator 122 is the same as that of the first attribute generator 121, a description thereof is omitted.

The first attribute generator 121 contains eight groups of an attribute value generator, a data ON/OFF unit for receiving the attribute value output from the attribute value generator, and a terminal (signal input terminal) connected to the data ON/OFF unit. Specifically, the first attribute generator 121 contains eight attribute value generators 136 to 143, eight data ON/OFF units 135 to 128 for receiving the attribute values output from the attribute value generators 136 to 143, and terminals (signal input terminals) s80 to s87 connected to the data ON/OFF units 135 to 128. The signals 62 to 55 are input to the terminals (signal input terminals) s80 to s87, respectively. Each data ON/OFF unit outputs the attribute value output from the corresponding attribute value generator when the input signal is H. In contrast, when the input signal is L, each data ON/OFF unit outputs nothing (all the output bits are zeros).

The attribute values output from the data ON/OFF units 135 to 128 are input to an OR gate group (OR12). The OR gate group (OR12) is formed by the same number of OR gates as the number of bits of the attribute value. Each OR gate computes the logical OR of the corresponding bits of the attribute values output by the data ON/OFF units 135 to 128. Attribute values output from the OR gate group (OR12) are transferred to the first attribute selector 125.

FIG. 20 shows the internal structure of the third attribute generator 123. Since the internal structure of the fourth attribute generator 124 is the same as that of the third attribute generator 123. a description thereof is omitted.

The third attribute generator 123 contains four groups of an attribute value generator, a data ON/OFF unit for receiving the attribute value output from the attribute value generator, and a terminal (signal input terminal) connected to the data ON/OFF unit. Specifically, the third attribute generator 123 contains four attribute value generators 144 to 147, four data ON/OFF units 152 to 148 for receiving the attribute values output from the attribute value generators 144 to 147, and terminals (signal input terminals) s40 to s43 connected to the data ON/OFF units 152 to 148. The signals 79 to 76 are input to the terminals (signal input terminals) s40 to s43, respectively. Each data ON/OFF unit outputs the attribute value transmitted thereto from the corresponding attribute value generator when the input signal is H. In contrast, when the input signal is L, each data ON/OFF unit outputs nothing (all the output bits are zeroes).

The attribute values output from the data ON/OFF units 152 to 148 are input to an OR gate group (OR13). The OR gate group (OR13) is formed by the same number of OR gates as the number of bits of the attribute value. Each OR gate computes the logical OR of the corresponding bits of the attribute values output from the data ON/OFF units 152 to 148. Attribute values output from the OR gate group (OR13) are transferred to the second attribute selector 126.

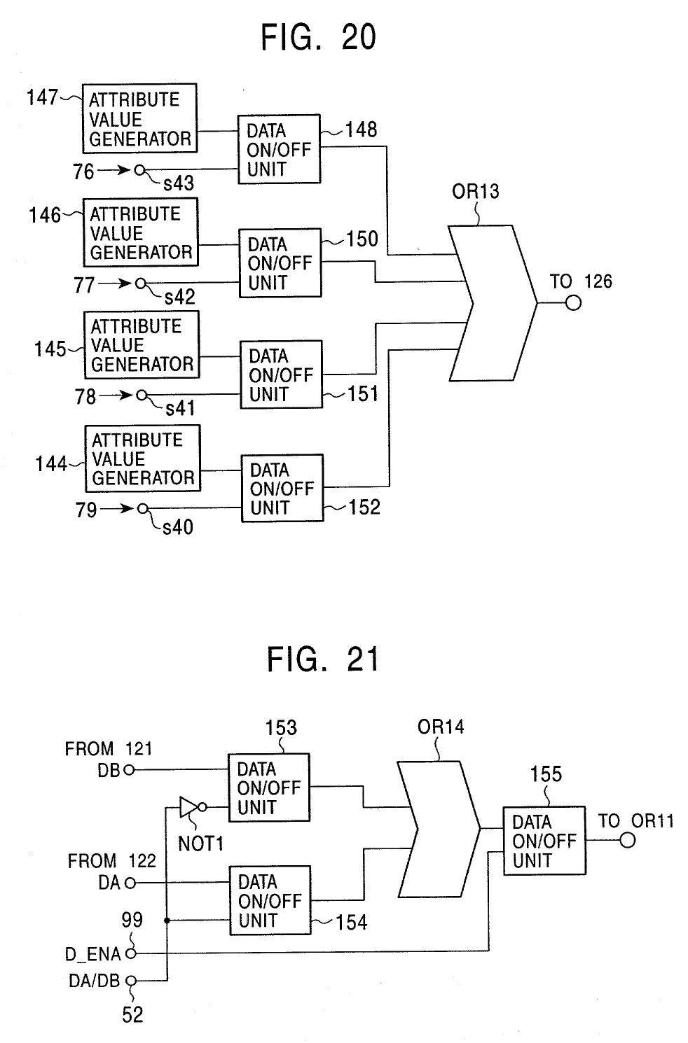

FIG. 21 shows the internal structure of the first attribute selector 125. Since the internal structure of the second attribute selector 126 is the same as that of the first attribute selector 125, a description thereof is omitted.

The first attribute selector 125 contains data ON/OFF units 153, 154, and 155, an OR gate group (OR14), an inverter (NOT1), a terminal group DB, a terminal group DA, a terminal D_ENA, and a terminal DA/DB. The data ON/OFF unit 153 receives the attribute values output from the first attribute value generator 121 via the terminal group DB. The data ON/OFF unit 153 receives the first timing signal 52 transferred from the timing generator 44 via the terminal DA/DB and the inverter (NOT1). The data ON/OFF unit 154 receives the attribute values output from the second attribute generator 122 via the terminal group DA. The data ON/OFF unit 154 receives the first timing signal 52 transferred from the timing generator 44 via the terminal DA/DB. When the input signal is H, each data ON/OFF unit outputs the attribute values transmitted thereto from the corresponding attribute generator. In contrast, when the input signal is L, each data ON/OFF unit outputs nothing (all the output bits are zeroes). Thus, when the first timing signal 52 input to the terminal DA/DB is H, the data ON/OFF unit 154 outputs the attribute values. When the first timing signal 52 is L, the data ON/OFF unit 153 outputs the attribute values.

The attribute values output from the data ON/OFF unit 153 or 154 are input to the OR gate group (OR14). The OR gate group (OR14) is formed by the same number of OR gates as the number of bits of the attribute value. Each OR gate computes the logical OR of the corresponding bits of the attribute values output from the data ON/OFF unit 153 or 154. Attribute values output from the OR gate group (OR14) are input to the data ON/OFF unit 155. The data ON/OFF unit 155 receives the signal 99 transferred from the timing generator 44 via the terminal D_ENA. When the input signal 99 is H, the data ON/OFF unit 155 outputs the attribute values transferred from the OR gate group (OR14). In contrast, when the input signal 99 is L, the data ON/OFF unit 155 outputs nothing (all the output bits are zeroes). The attribute values output from the data ON/OFF unit 155 are transmitted to the OR gate group (OR11).

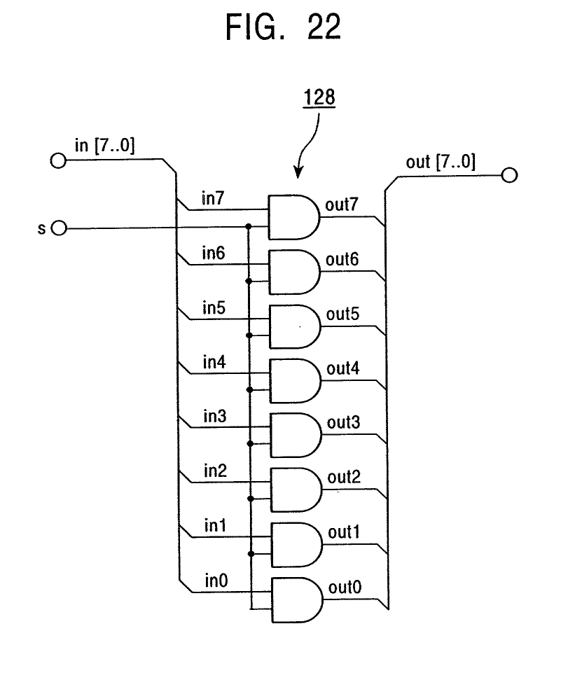

FIG. 22 illustrates the internal structure of the data ON/OFF unit 128. Since the internal structure of each of the data ON/OFF units 129 to 135 and 148 to 155 is the same as that of the data ON/OFF unit 128, descriptions thereof are omitted.

The data ON/OFF unit 128 contains the same number of AND gates as the number of bits of the input attribute value (8 bits in FIG. 22). When the signal input from a terminal s is H, the data ON/OFF unit 128 outputs the attribute value, which is input from an input terminal group in, from an output terminal group out. When the signal input from the terminal s is L, the data ON/OFF unit 128 outputs nothing from the output terminal group out (all the bits from the output terminal group OUT are zeroes).

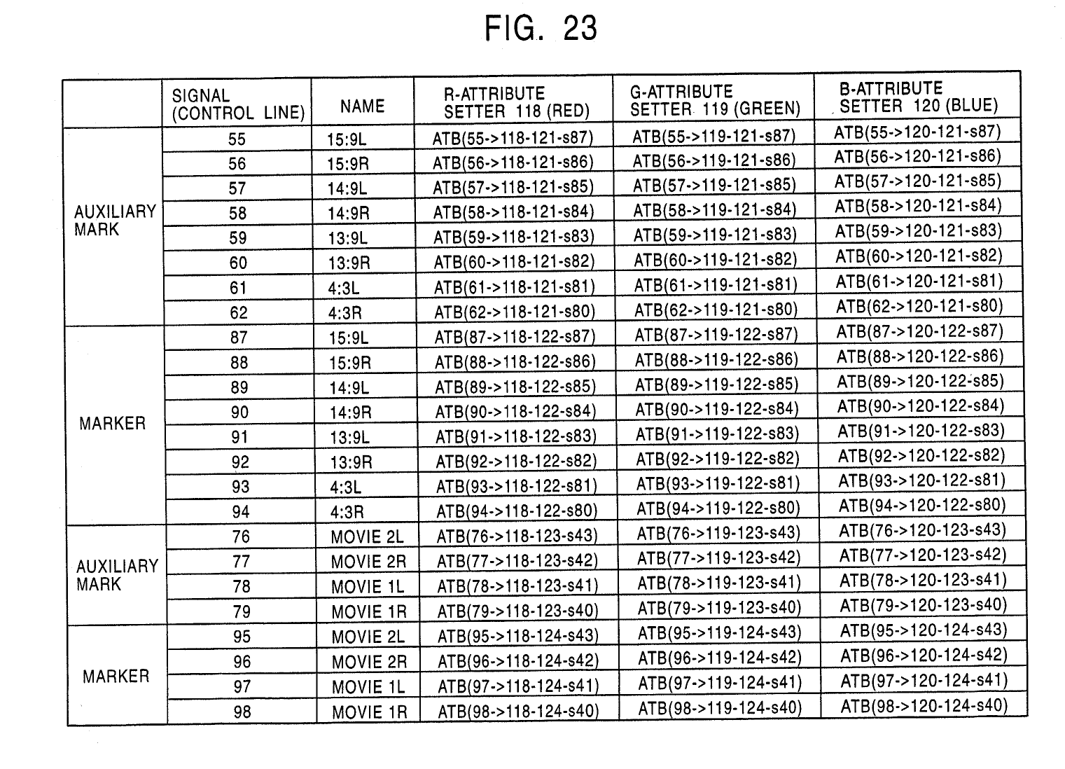

FIG. 23 is a table showing a list of display types (auxiliary mark or marker), aspect ratios, signals (control lines) used in display types, and attribute values extracted by these signals (control lines). In this table, in order to clarify a path in which each signal is transmitted, for example, the signal 55 is expressed as 55->118-121-s87. Similarly, the signal 56 is expressed as 56->118-121-s86. The signal 57 is expressed as 57->118-121-s85. The signal 58 is expressed as 58->118-121-s84. The signal 59 is expressed as 59->118-121-s83. The signal 60 is expressed as 60->118-121-s82. The signal 61 is expressed as 61->118-121-s81. The signal 62 is expressed as 61->118-121-s80.

For example, when the signal 55, i.e., 55->118-121-s87, is input to the terminal s87, the attribute value extracted from the attribute value generator 143 is expressed as ATB(55->118-121-s87). Similarly, the attribute value corresponding to the signal 56, i.e., 56->118-121-s86, is expressed as ATB(56->118-121-s86). The attribute value corresponding to the signal 57, i.e., 57->118-121-s85, is expressed as ATB(57->118-121-s85).

The first attribute generator 121 and the second attribute generator 122 each output attribute values corresponding to those of the signals 55 to 62 and the signals 87 to 94 from the timing generator 44 which are at the H level, and these attribute values are input to the first attribute selector 125.

The third attribute generator 123 and the fourth attribute generator 124 each output attribute values corresponding to those of the signals 76 to 79 and the signals 95 to 98 which are at the H level, and these attribute values are input to the second attribute selector 126.

The signals 55 to 62 indicate the horizontal timing of auxiliary marks. More specifically, the signal 55 becomes H at the time the 15:9 left auxiliary mark is displayed. The signal 56 becomes H at the time the 15:9 right auxiliary mark is displayed. The signal 57 becomes H at the time the 14:9 left auxiliary mark is displayed. The signal 58 becomes H at the time the 14:9 right auxiliary mark is displayed. The signal 59 becomes H at the time the 13:9 left auxiliary mark is displayed. The signal 60 becomes H at the time the 13:9 right auxiliary mark is displayed. The signal 61 becomes H at the time the 4:3 left auxiliary mark is displayed. The signal 62 becomes H at the time the 4:3 right auxiliary mark is displayed. In other words, these signals do not become H at the same time. In accordance with the above-described timing, the attribute values corresponding to the signals at the H level are output.

For example, when the attribute values are set as follows:

ATB(55->118-121-s87)=255;

ATB(56->118-121-s86)=255;

ATB(57->118-121-s85)=200;

ATB(58->118-121-s84)=200;

ATB(59->118-121-s83)=240;

ATB(60->118-121-s82)=240;

ATB(61->118-121-s81)=100; and

ATB(62->118-121-s80)=100,

the first attribute generator 121 outputs the attribute values in this order. In other words, each attribute value which is output from the first attribute generator 121 and which indicates the red component of the 15:9 auxiliary mark is 255. Each attribute value which is output from the first attribute generator 121 and which indicates the red component of the 14:9 auxiliary mark is 200. Each attribute value which is output from the first attribute generator 121 and which indicates the red component of the 13:9 auxiliary mark is 240. Each attribute value which is output from the first attribute generator 121 and which indicates the red component of the 4:3 auxiliary mark is 100. The attribute values are output every time the delayed horizontal sync signal 35 is input.

The signals 87 to 94 indicate the horizontal timing of markers. Specifically, the signal 87 becomes H at the time the 15:9 left marker is displayed. The signal 88 becomes H at the time the 15:9 right marker is displayed. The signal 89 becomes H at the time the 14:9 left marker is displayed. The signal 90 becomes H at the time the 14:9 right marker is displayed. The signal 91 becomes H at the time the 13:9 left marker is displayed. The signal 92 becomes H at the time the 13:9 right marker is displayed. The signal 93 becomes H at the time the 4:3 left marker is displayed. The signal 94 becomes H at the time the 4:3 right marker is displayed. Thus, these signals do not become H at the same time. In accordance with the foregoing timing, the attribute values corresponding to the signals at the H level are output. The type of marker to be displayed is determined by the marker switching signal 43 input to the decoder 103.

For example, when the attribute values are set as follows,

ATB(87->119-122-s87)=255;

ATB(88->119-122-s86)=255;

ATB(89->119-122-s85)=200;

ATB(90->119-122-s84)=200;

ATB(91->119-122-s83)=240;

ATB(92->119-122-s82)=240;

ATB(93->119-122-s8l)=100; and

ATB(94->119-122-s80)=100,

each attribute value which is output from the second attribute generator 122 and which indicates the green component of the 15:9 marker is 255. Each attribute value which is output from the second attribute generator 122 and which indicates the green component of the 14:9 marker is 200. Each attribute value which is output from the second attribute generator 122 and which indicates the green component of the 13:9 marker is 240. Each attribute value which is output from the second attribute generator 122 and which indicates the green component of the 4:3 marker is 100. One of these attribute values is output as the attribute value of the marker selected by the marker switching signal 43.

As described above, the attribute value output from the first attribute generator 121 and the attribute value output from the second attribute generator 122 are input to the first attribute selector 125. In accordance with the attribute values of the auxiliary marks, which are output from the first attribute generator 121, the first attribute selector 125 gives preference to the attribute value of the marker output from the second attribute generator 122. Alternatively, the first attribute selector 125 may output none of the attribute values of the auxiliary marks and the markers.

The attribute values output from the first attribute generator 121 are input to the first attribute selector 125, and the attribute values are input to the data ON/OFF unit 153 in the first attribute selector 125. The attribute values output from the second attribute generator 122 are input to the first attribute selector 125, and the attribute values are input to the data ON/OFF unit 154 in the first attribute selector 125. In contrast, the first timing signal 52 output from the timing generator 44 is input to the terminal DA/DB of the first attribute selector 125.

The first timing signal 52 becomes H not at the time of the auxiliary mark, but at the time of the marker. More specifically, as shown in FIG. 11, one (or none) of the signals 74 and 85 each indicating the timing of the marker is selected by the AND gates (AND19 and AND20) and the OR gate (OR8), and the selected signal becomes the first timing signal 52. The selection is performed in accordance with the signals 99 and 100. As a result, the first timing signal 52 becomes H not at the time of the auxiliary mark, but at the time of the marker.

The first timing signal 52 becomes H at the time of the marker. Thus, the data ON/OFF unit 154 is selected, and the attribute value of each marker, which is output from the second attribute generator 122, is selected. At other times (other than the time of the marker), the first timing signal 52 becomes L. Thus, the data ON/OFF unit 153 is selected, and the attribute value of each auxiliary mark, which is output from the first attribute generator 121, is selected.

The selected attribute values are output from the OR gate group (OR14), and the attribute values are input to the data ON/OFF unit 155. In accordance with the signal 99 determined in accordance with the marker switching signal 43, the data ON/OFF unit 155 determines whether to output the attribute values transferred from the OR gate group (OR14). If the determination is negative, none of the attribute values of the auxiliary marks and the markers is selected.

Since the operation of the second attribute selector 126 is the same as that of the first attribute selector 125, a description thereof is omitted.

The output of the first attribute selector 125 and the output of the second attribute selector 126 are input to the OR gate group (OR11), and the OR gate group (OR11) computes the logical OR. The computed logical OR becomes the attribute setting R signal 49.

When the signal 99 is H and the signal 100 is L, the output of the first attribute selector 125 becomes the attribute setting R signal 49. When the signal 99 is L and the signal 100 is H, the output of the second attribute selector 126 becomes the attribute setting R signal 49. When both of the signals 99 and 100 are L, neither output is selected, and the attribute setting R signal 49 is zero. The signals 99 and 100 are determined in accordance with the marker switching signal 43.

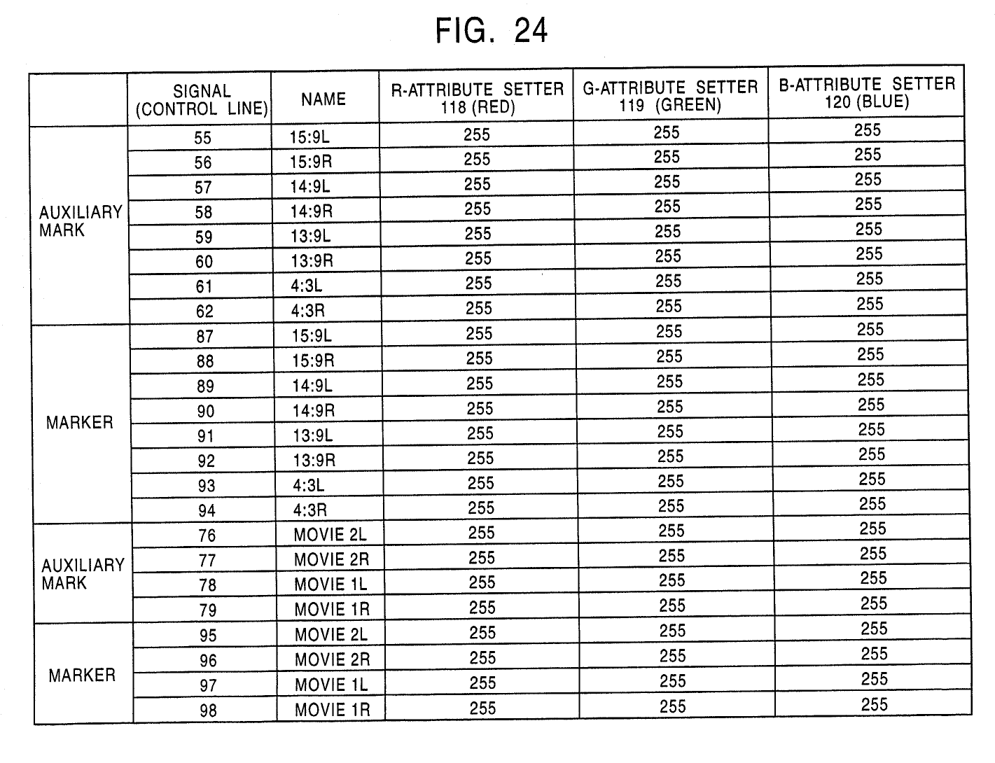

FIG. 24 shows an example of a list of attribute values set to the R-attribute setter 118, the G-attribute setter 119, and the B-attribute setter 120. In this example, 255 is set to all of the attribute value generators. As a result, the auxiliary marks and the markers are white having a luminance of 100%.

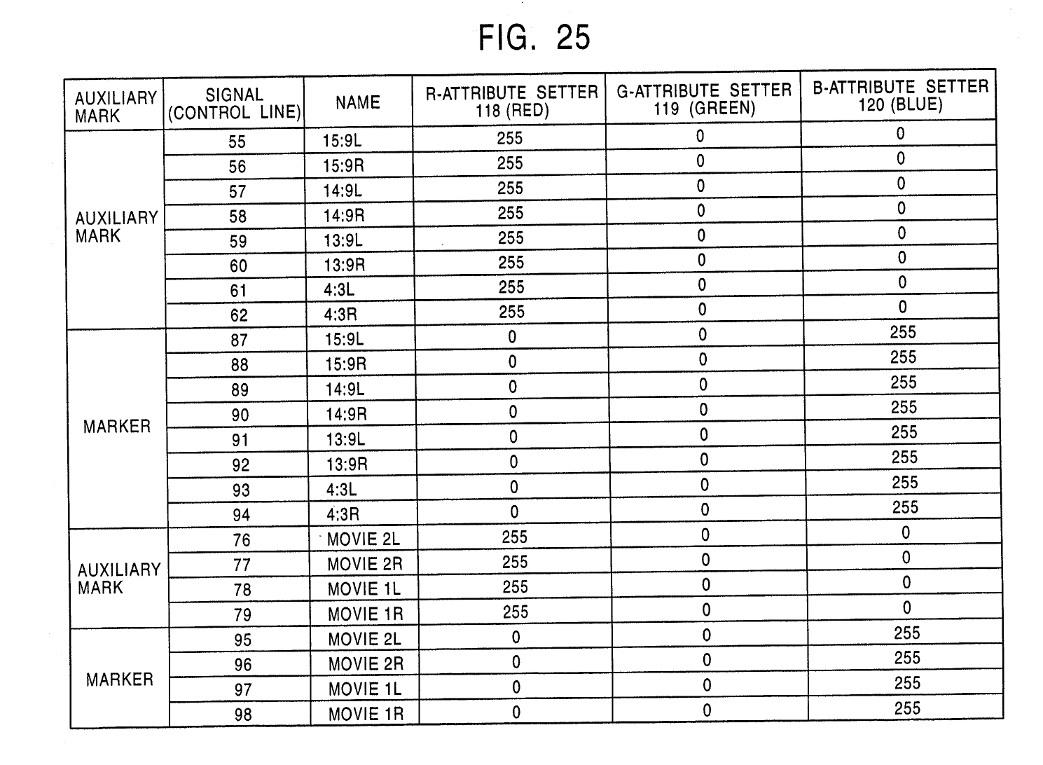

FIG. 25 shows another example of a list of attribute values set to the R-attribute setter 118, the G-attribute setter 119, and the B-attribute setter 120. In this example, 255 is set to attribute value generators, which correspond to the auxiliary marks, in the R-attribute setter 188; 255 is set to attribute value generators, which correspond to the markers, in the B-attribute setter 120; and 0 is set to the remaining attribute value generators. As a result, the auxiliary marks are red, and the markers are blue.

By setting an arbitrary attribute value ranging form 0 to 255 to each attribute value generator, the luminance and the color of each auxiliary mark and each marker can be arbitrarily set. At the same time, the luminance and the color can be made different for, for example, the left and right lines indicating the 4:3 marker.

What is claimed is:

1. An image display device comprising a display screen with a predetermined aspect ratio, the display screen being capable of displaying a plurality of sections,
wherein a scale corresponding to each section is displayed on a border of each section or on an extension of the border.

2. An image display device according to claim 1, wherein one of the plurality of sections can be selected as a selected section, and a display attribute of a selected scale corresponding to the selected section is made different from a display attribute of an unselected scale corresponding to an unselected section other than the selected section.

3. An image display device according to claim 2, wherein part of the selected scale is provided on the border of the selected section corresponding to the selected scale and in the vicinity of a central portion of the display screen, and
the unselected scale is provided on the border of the unselected section corresponding to the unselected scale and in the vicinity of a peripheral portion of the display screen.

4. An image display device according to claim 2, further comprising selection means for selecting a desired section from among the plurality of sections as the selected section, wherein, in cooperation with a selection operation performed by the selection means, a scale corresponding to the selected section is selected as the selected scale.

5. An image display device comprising:
a display screen with a predetermined aspect ratio, the display screen being capable of displaying a plurality of sections; and
a scale setter for determining a display attribute of a scale displayed on a border of each section or on an extension of the border, for generating a scale signal indicating the determined display attribute, and for replacing a predetermined portion of an image signal for displaying an image on the display screen with the scale signal.

6. An image display device according to claim 5, wherein the scale setter comprises:
attribute setting means for generating a plurality of scale signals indicating different display attributes; and
replacement means for replacing the predetermined portion of the image signal for displaying the image on the display screen with one of the plurality of scale signals generated by the attribute setting means.

7. An image display device according to claim 6, wherein the scale setter further comprises timing determination means for determining a time at which the replacement means replaces the predetermined portion of the image signal with one of the plurality of scale signals in accordance with a sync signal of the image displayed on the display screen.

8. An image display device according to claim 6, wherein the scale setter further comprises:
a switch; and
switching means for sequentially switching, among the plurality of scale signals generated by the attribute setting means, the scale signal for replacing the predetermined portion of the image signal by the replacement means every time the switch is turned ON.
